(19) United States
(12) Patent Application Publication
(10) Pub. No.: US 2023/0252395 A1
(43) Pub. Date: Aug. 10, 2023

(54) A QUAY CRANE OPERATION METHOD

(71) Applicant: Portchain ApS, København K (DK)

(72) Inventors: Michael Lindahl, København K (DK); Anders Olivarius, Frederiksberg C (DK); Thor Thorup, Vedbek (DK); Niels Adam Hedeager Kristiansen, København K (DK)

(73) Assignee: Portchain ApS, København K (DK)

(21) Appl. No.: 18/005,257

(22) PCT Filed: Jul. 9, 2021
(86) PCT No.: PCT/DK2021/050236

§ 371 Date: Jan. 12, 2023

(30) Foreign Application Priority Data
Jul. 13, 2020 (DK) PA 2020 70485

(51) Int. Cl. G06Q 10/0831; B66C 13/18; G06Q 10/0631; G06Q 10/083

(52) U.S. Cl. CPC G06Q 10/0831; B66C 13/18; G06Q 10/06314; G06Q 10/0838

(57) ABSTRACT

A method for allocating and/or operating quay cranes at a container carrier terminal. The method includes scheduling a container carrier associated with static carrier information to perform a container carrier berth at the container carrier terminal and further supplying a container carrier entry associated with the container carrier berth to a container carrier terminal system associated with the container carrier terminal. The method further includes generating an estimated container-related berth workload associated with the container carrier berth based on the static carrier information, and allocating the quay cranes to crane time windows which lie within an expected duration of the container carrier berth, wherein the allocating quay cranes is performed in the container carrier terminal system prior to the container carrier berth and is based on the estimated container-related berth workload. The quay cranes are then operated to perform transfer of containers associated with the container carrier during the crane time window.

### FIELD OF THE INVENTION

The present invention relates to scheduling, allocating a quay crane in a container carrier terminal.

### BACKGROUND OF THE INVENTION

Quay cranes are a crucial element of the transport industry. They facilitate transfer of containers between container carriers and container carrier terminals, to ensure that goods are delivered to consumers and production facilities worldwide.

However, in the supply chains of the transport industry, quay cranes are typically a bottleneck, which constraint the flow of goods. Therefore, improving quay crane operations is highly desirable.

The framework for scheduling the operation of quay cranes is often facilitated by long-standing contractual agreements, such as so-called pro-forma plans, between managers of container carriers, i.e. shipping companies, and managers of container carrier terminals. Such a long-standing contractual agreement may for example be an annual agreement which addresses a weekly berth of container carriers at a container carrier terminal. The agreement may further address a number of containers which may be transferred during container carrier berths.

Scheduling of quay crane operations based on long-term agreements is typically not viable in practice, since the number of containers in the agreement is inaccurate. Instead, detailed operations of quay cranes may for example be scheduled one to two days prior to the actual arrival of a container carrier, where the arrival time and the container stowage plan of the container carrier is relatively well-known. However, both long-term unreliable planning and short-term planning is prone to be inefficient, and, consequently, the operation of container carriers and container carrier terminals are wasteful, leading to slower delivery of goods and increased emission of greenhouse gasses. A container carrier may for example spend excess fuel to rush to a container carrier terminal which upon arrival is not yet prepared to transfer containers to and from the container carrier, referred to as “rush to wait”.

### SUMMARY OF THE INVENTION

The inventors have identified the above-mentioned problems and challenges related to scheduling quay crane operations before receiving an indication of the required workload, and subsequently made the below-described invention which may increase reliability of delivery times of goods, reduce the emission of greenhouse gasses, generally improve efficiency of crane utilization, and other advantages described below.

The invention relates to a method for operating and/or allocating at least one quay crane at a container carrier terminal, said method comprising:
scheduling a container carrier to perform a container carrier berth at said container carrier terminal, wherein said container carrier is associated with static carrier information;
supplying a container carrier entry associated with said container carrier berth to a container carrier terminal system associated with said container carrier terminal;
generating an estimated container-related berth workload associated with said container carrier berth based on said static carrier information;
allocating said at least one quay crane to a crane time window which lies at least partially within an expected duration of said container carrier berth, wherein said allocating said at least one quay crane is performed in said container carrier terminal system prior to said container carrier berth and is based on said estimated container-related berth workload.

In an embodiment of the invention, the method further comprises: operating said at least one quay crane to perform transfer of containers associated with said container carrier during said crane time window.

By allocating and preferably finally operating a quay crane based on generating an estimated container-related berth workload, which in turn is based on static carrier information, it is possible to improve quay crane operations to become more accurate and precise, which is advantageous. This could for example involve estimating the number of containers or required container moves based on the sparse information available several weeks before the container carrier is scheduled to arrive and use this estimate for long-term quay crane allocation planning instead of either having to rely on the ballpark figures or maximum numbers agreed in the pro-forma schedule, or having to postpone planning until declared specific numbers are available a few hours or days before arrival. Several other examples and use cases within the scope of the invention are provided herein.

Generally, the operation efficiency of an entire container carrier terminal with many quay cranes may be improved by implementation of the method of the invention. Namely, a more well-organized and well-operated container carrier terminal may lead to a more efficient and rapid delivery of goods to consumers and production facilities, which is advantageous. Moreover, a container carrier terminal may be considered a potentially hazardous working environment, and a more well-organized container-carrier terminal may thus have a reduced risk of work accidents, which is advantageous. By improving the allocation of quay cranes for a smoother and more efficient operation, the wear on the quay cranes and related equipment may be reduced, leading to less maintenance breaks. The improved allocation e.g. involving less of moving cranes around between tasks, may also reduce waiting time, thereby improving the efficiency even further.

Container carrier terminals are susceptible to several different types of disruptions, which may interrupt quay crane schedules and operations. For example, container carrier delays, unknown stowage of container carriers, extreme weather at the container terminal, black swan events, and unclear availability of gangs of workers. A black swan event may be understood as an event that comes as a surprise and has a major effect, with relevant examples within shipping being the 2017 NotPetya computer virus attack and the COVID-19 pandemic. Any of the above-mentioned disruptions may easily delay transportation of goods. By allocating and/or operating a quay crane based on generating an estimated container-related berth workload, which in turn is based on static carrier information, it is possible to improve scheduling of quay crane operations to become more flexible, which in turn enables a container carrier terminal to engage and optimally manage the many disruptions of shipping, thus reducing delay of goods, which is advantageous.

The shipping industry is associated with enormous emissions of greenhouse gases. Particularly, the consumption of bunker fuel of container carriers is approximately exponentially dependent on the velocity of the container carrier. Accordingly, every additional knot becomes increasingly expensive for the environment. By allocating a quay crane based on generating an estimated container-related berth workload, which in turn is based on static carrier information, it is possible to improve allocation of quay crane operations to reduce the time which container carriers have to spend in container carrier terminals, and consequently, the cruising speed of container carriers between terminals can be decreased, which is advantageous in the context of emission of greenhouse gases.

The increased flexibility according to the invention further allows improved long-term planning of maintenance of quay cranes and the quay which is advantageous. The invention further improves the capacity to receive unscheduled container carriers, e.g. so-called inducement calls, which may further improve the delivery time of goods to consumers and reduce emission of greenhouse gases, which is advantageous. This may, for example, be relevant if a neighboring container terminal is unable to receive a container carrier due to poor planning or weather conditions.

A container carrier may be understood as a ship, seaborne freighter, or seaborne vessel quipped for carrying and transporting containerized cargo, i.e. containers with cargo. A container carrier may therefore also be referred to as a container ship or a container vessel. In the context of the present disclosure, a container may be understood as an intermodal container and/or a shipping container. A container carrier terminal may be understood as an initial, intermediate, or final destination facility that enables containers to switch methods of transport en route to their final destination. Containers are transported on water by container carriers and shipped to a container carrier terminal for unloading before being transported further by land-based transportation such as by trains and trucks to their final destination or by another container carrier. Likewise, the container carrier terminal may facilitate a switch from land-based transportation to a container carrier in the transport of containers. The container carrier terminal may comprise one or more quays for berthing of container carriers and at least one quay crane for loading/unloading of containers. The container carrier terminal may, for example, further comprise one or more prime movers for further moving containers within the container carrier terminal and a container yard for temporary storage of containers.

A quay crane may be understood as a quayside (or dockside) crane arranged to perform transfer of containers, e.g. loading/unloading containers to/from container carriers. The quay crane may therefore also be referred to as a ship-to-shore crane. A quay crane may additionally be referred to as a gantry crane or a container crane. The quay crane may typically be configured to move along rail tracks along a quay side of the container carrier terminal such that the quay crane may be positioned at necessary positions relative to the berthing container carrier for the loading/unloading of containers. The quay crane may for example be operated by a gang of workers temporarily or permanently dedicated to that quay crane or, alternatively, be an automatically operated quay crane, e.g. an autonomous quay crane. The quay crane comprises a crane boom for reaching in over a berthing container carrier to perform transfer of containers. The boom may be hinged to allow passage of large container carriers beneath or it may be fixed to reduce airspace being taken up.

A container carrier berth may for example relate to the event and course of work tasks relevant for a container carrier and a container carrier terminal from the arrival of the container carrier at the container carrier terminal to the departure of the container carrier from the container carrier terminal. A central element of a container carrier berth is operating at least one quay crane to perform transfer of container to/from/onboard the container carrier. A container carrier berth may for example further relate to docking of the container carrier along the quay.

A container carrier terminal system may be understood as a system for managing a container carrier terminal, e.g. a computer-implemented system for managing terminal resources relating to berthing of container carriers at the container carrier terminal, e.g. for managing allocation of at least one quay crane.

A container carrier entry may be understood as a representation of a container carrier berth in the container carrier terminal system. The container carrier entry comprises or links to data relevant to the container carrier berth of the container carrier at the container carrier terminal. This data may for example comprise any of a tentative arrival time, a tentative departure time, a scheduled berthing position along a quay of the container carrier terminal, a contractual container-related berth workload, an estimated container-related berth workload, a declared container-related berth workload, an actual container-related berth workload, and details on how many and which containers need to be loaded, unloaded, and/or redistributed. The container carrier entry may further relate to specifics regarding the container carrier itself, such as the length, width, height and depth/draft of the container carrier. The container carrier entry may further comprise data indicative of previous port calls or future port calls of the container carrier with respect to the berthing of the container carrier at the container carrier terminal.

Static carrier information may be understood as information relating to the carrier and which is generally static, i.e. the information does not change substantially on time scales relevant for berth planning and crane allocation. Examples of static carrier information is a name or tag which identifies a container carrier, a shipping company related to a container carrier, a size related to a container carrier, and a container volume related to a container carrier. Static carrier information may further relate to information relating to a route of a container carrier, and in that sense static carrier information may also be referred to as static route information. Static carrier information may in other words be considered as such data related to a container carrier or shipping route which are the same for each visit to the container terminal, i.e. each berth of this container carrier or shipping route. This is opposed to non-static data that changes from berth to berth even of the same ship in the same container terminal, such as arrival and departure times, actual number of container moves required this time, etc.

Typically, container carriers sail a predetermined container carrier route which include container carrier berths at several predetermined terminals. A shipping company may then provide many container carriers to sail the route, such that a steady arrival and departure of container carriers may be ensured throughout the route. In some sense, such a route may be considered analogous to a bus route in which several buses visit several bus stops to ensure a steady arrival and departure of busses thought the bus route. In the technical field of container shipping such a route may also be referred to as a service, a service route, and a shipping route.

Contractual agreements between shipping companies and container carrier terminals, e.g. pro-forma plans, may typically concern scheduling of such a container carrier route, e.g. the frequency with which any container carrier of that route may visit a given terminal, a contractual number of containers to be loaded and unloaded etc.

Cargo capacity may be understood as a measure of the amount of containerized cargo. For example, a number of containers or a number of units of TEU, where TEU is twenty-foot equivalent units, which is a unit of cargo capacity often used to describe the capacity of container carriers and container terminals. Sometimes a container carrier gets completely unloaded and/or loaded during a single berth, and thereby the required workload roughly corresponds to the cargo capacity of the container carrier. However, more typically the container carriers unload and load only partially in each terminal they visit and the required workload is thereby not the total cargo capacity of the vessel.

A container-related berth workload may for example relate to a cargo capacity to be loaded, unloaded, and/or redistributed by at least one quay crane in relation to a container carrier berth. Alternatively, a container related berth workload for example relate to a number of quay crane workhours. The container-related berth workload may be a single number representing the total amount of work, e.g. by a number of container moves or crane hours, or it may be a multi-dimensional parameter that provides individual numbers for loading, unloading and redistribution, respectively, to allow for more accurate allocation depending on the types of tasks. Regardless of the way of quantifying the workload, one or more cranes may be allocated to match the container-related berth workload. A balance exists between the number of cranes allocated and the time required to carry out the container moves, as generally the more cranes allocated for the workload, the faster the work can be done. Therefore, the invention of generating an estimated container-related berth workload based on static carrier information, i.e. before knowing the actual cargo capacity that will have to be loaded, unloaded and/or redistributed in relation to a future berth, and performing quay crane allocation on the basis of the estimated workload, allows for planning and adjusting the crane-amount/crane-time balance significantly earlier than when waiting for actual workload information, thereby having more freedom to make an efficient allocation because more and more parameters get locked as the berth date approaches.

Allocating at least one quay crane to a crane time window based on the estimated container-related berth workload may be understood as calculating a number of cranes and a start time and end time of a crane time window from the information about the estimated workload associated with a scheduled berth, and earmark a specific number of quay cranes, preferably also specific quay cranes, to be used in the operation of the specific scheduled berth for the specific crane time window, which at the time of performing the step of allocation lies in the future. The allocation may preferably render the allocated crane unavailable for further allocations overlapping the crane time window. The calculations may reveal several solutions, for example using a single crane for a relatively long crane time window, or using multiple cranes for a relatively shorter crane time window, but the allocation step results in a specific solution being selected and promoted to a specific allocation of cranes for a specific crane time window.

The resulting crane allocation may form part of a crane operation plan or terminal resource plan on the basis of which the cranes are operated when the crane time window arrives in real time. The allocated crane time window is preferably within the expected duration of the scheduled berth, but sometimes the calculations may reveal that no possible crane allocation exists where the available cranes can perform the estimated workload within the scheduled berth duration. In that case, one solution is to for the allocation to define a crane time window which partially extends out of the expected duration of the berth, which may require the scheduled berth to be modified accordingly. The crane time window may be an uninterrupted duration of time, in which the allocated at least one crane operates continuously on a single port call, or it may in various embodiments be a crane time window consisting of two or more sub-time-windows, e.g. indicating that a respective crane is allocated to operate on a respective berth during those sub-time-windows, but is available for other operations between the sub-time-windows. When more than one crane is allocated to the same scheduled berth, e.g. a scheduled berth relating to long container carrier allowing, e.g., four or five cranes to operate it simultaneously, the crane time windows need not be equal for each crane. For example, five cranes may allocated to operate in relation to the respective berth for the first two hours of the berth, and only two of the cranes continue the operation for the next two hours to finish the estimated workload, while the other three cranes are freed to be allocated for other scheduled berths.

Besides using the generated estimated workload, the allocation step may in various embodiments improve the allocation of cranes by further taking into account other scheduled berths which are near in time and/or space and for which cranes should also be allocated, and by possibly also further taking into account various further resource demands of the container carrier and the available terminal resources and related constraints of the terminal.

Long-term contractual agreements, e.g. pro-forma plans, between managers of container carriers, e.g. shipping companies, and managers of container carrier terminals may typically relate to an agreed-upon contractual cargo capacity to be transferred during a container carrier berth. A contractual container-related berth workload may be understood as a measure of this contractual cargo capacity. The actual container-related berth workload may be understood as a measure of the actual cargo capacity which needs to be transferred by at least one quay crane during the container carrier berth. The actual container-related berth workload may typically be very different from the contractual container-related berth workload, which highlights the importance of the invention, which in typical embodiments aims to provide an estimated container-related berth workload which is as close as possible to the—at that time unknown—actual container-related berth workload, such that at least one quay crane may be allocated accordingly for a more efficient future operation. However, note that embodiments of the invention are not restricted to any particular constraints of the estimated container-related berth workload.

Shortly before, e.g. 1-2 days before some container carrier berths, a manager of the container carrier or shipping company, e.g. a captain of the container carrier, may for example declare the number containers which need to be transferred during the container carrier berth. As such, a declared container-related berth load may be received. However, with such a short duration for planning quay crane allocation, it is not possible to allocate resources, e.g. at least one quay cranes optimally for efficient operation.

In an embodiment of the invention, said container carrier terminal system is a computer-implemented container carrier terminal system.

In an embodiment of the invention, said step of generating an estimated container-related berth workload is performed by data processing equipment.

In an embodiment of the invention, said step of allocating said at least one quay crane based on said estimated container-related workload is performed by data processing equipment.

By computer-implemented is understood that, e.g. the container carrier entry and the estimated container-related berth workload are stored in digital form in the same or different locations and computer storage types, and that one or more processors are provided to carry out at least one or more steps of the method according to the present invention, such as the step of generating an estimated container-related berth workload. In various embodiments, the container carrier terminal system further comprises a graphical user interface (GUI), hence also computer-implemented, i.e. providing a graphical view to a user by a display and receiving input from the user by any ordinary or special computer input, e.g. by keyboard, mouse, or a touchscreen. The graphical user interface of the container carrier terminal system may thus be regarded as an interface between the system and a user or operator of the system, e.g. a berth planner. The container carrier terminal system may be implemented and running on a single computer, or have different modules separated to different computers, e.g. one computer running an allocation engine/optimization engine, and another computer running the graphical user interface. The container carrier terminal system may be using distributed processing, for example cloud-based processing. The storage of data may be at separate data servers, e.g. cloud-based, or be local in connection with the processing computers.

Such components of a computer implementation, e.g. memory, processor(s), communication infrastructure, etc., may also be referred to as data processing equipment, which may advantageously be utilized for executing at least one or both of the steps of generating an estimated container-related berth workload and allocating at least one crane on the basis thereof.

In an embodiment of the invention, said estimated container-related berth workload is generated automatically.

In an embodiment of the invention, said step of generating an estimated container-related berth workload is performed automatically.

In an embodiment of the invention, said step of allocating said at least one quay crane based on said estimated container-related workload is performed automatically.

Implementing the container carrier terminal system may allow a small or large degree of automatization. For example, the estimated container-related berth workload may advantageously be generated automatically, for example upon input from a user. Or, for example, the step of generating an estimated container-related berth workload may be performed automatically, e.g. such that the estimated container-related berth workload is calculated without user input.

In some embodiments of the invention, the estimated container-related berth workload is automatically generated every time new information relevant for the estimated container-related berth workload is received. In some of these embodiments, a user may receive a notice that a new estimated container-related berth workload has been generated, and in some embodiments receive a notice if the crane allocation is not suitable for the new estimated container-related berth workload.

Automatization of the method is advantageous, since it allows rapid rescheduling and allocation, and automatic updates when new information is received.

Implementing the method on a computer is advantageous, since it permits an increased level of automatization, organization, and communication between different parties.

In an embodiment of the invention, said step of allocating said at least one quay crane based on said estimated container-related workload is performed automatically upon said estimated container-related berth workload having been generated.

Parts of the method may advantageously be fully automatic, so that the step of generating the estimated container-related workload is performed automatically when the required information is available or updated, e.g. a scheduled berth and associated static carrier information, and which generated estimate triggers the step of automatically allocating cranes based on the estimated workload, thereby in effect automatically allocating cranes or updating a prior allocation, upon receipt of new information.

In an embodiment of the invention, said step of allocating said at least one quay crane comprises said crane time window to lie fully within said expected duration of said container carrier berth.

In an embodiment of the invention, said step of allocating said at least one quay crane further comprises allocating a quay crane of said at least one quay crane to a quay crane position.

A quay crane position may for example be understood as a position or an interval along the quay in the container carrier terminal of the quay crane. A quay crane may preferably be allocated to a position where it is able to perform transfer of containers associated to a container carrier.

Allocating a quay crane to a quay crane position is advantageous, since it ensures that the quay crane is prepared to perform transfer of containers which ensures delivery of goods.

Further, as multiple quay cranes cannot be positioned at the same position, and typically cannot move past each other along a quay, it is advantageous to consider and allocate quay crane positions as part of the step of allocating quay cranes, to ensure availability during the crane time window of not only the relevant crane(s) but also the relevant position(s).

In an embodiment of the invention, said step of operating said at least one quay crane comprises moving a quay crane of said at least one quay crane from a respective first quay crane position to a respective second quay crane position.

The first quay crane position may for example be a position along the quay where the quay crane has loaded/unloaded shipping containers from a previous container carrier in a previous crane time window and the second quay crane position may be another position of the quay crane along the same quay where a container carrier is present and where loading/unloading of shipping containers is required.

The first and second quay crane positions may also refer to positions of the crane adjacent to the same container carrier. For example, when a container carrier is berthing a redistribution of shipping containers may be needed, i.e. the quay crane may have to move a shipping container from one position to another position along the length of the container carrier.

Moving a quay crane is advantageous, since it ensures that the quay crane can properly access relevant containers to ensure a flow of goods to consumers and production facilities. When the moving of quay cranes is further performed on the basis of the crane allocation performed by the invention, it becomes further advantageous because the planning ahead by allocation in good time before the berth eliminates or at least reduces the risk of one crane being required at two positions at the same time, or one crane's position preventing an intended movement of another crane.

In an embodiment of the invention, said allocating said at least one quay crane is based on an estimated time duration of moving a quay crane of said at least one quay crane from a said first quay crane position to a said second quay crane position.

In some embodiments of the invention, the allocation of at least one quay crane to a crane time window takes into account that a quay crane has to move from a first crane position to a second quay crane position. Various embodiments may include the moving time as part of the allocated crane time window, or may allocate move time windows between the crane time windows to allow for the movement.

In an embodiment of the invention, said allocating said at least one quay crane is based on crane allocation constraints.

In container terminals, quay cranes may typically have certain constraints. Crane allocation constraints may, for example, be that a quay crane have a limited range along the quay in which it is able to move/operate, a quay crane is not able to pass through/around other quay cranes, a minimum distance is required between neighboring quay cranes, in some time periods a quay crane does not have a dedicated gang of workers to operate it, a quay crane have a limits relating to a size of container carriers, e.g. height (air draft) or width (beam) such that it cannot fully operate certain container carriers etc.

Allocating at least one quay crane based on crane allocation constraints is advantageous, since it reduces risk of an infeasible allocation of a quay crane, e.g. an allocation with cannot be carried out/operated in practice.

In an embodiment of the invention, said allocating said at least one quay crane comprises allocating a plurality of quay cranes to a plurality of crane time windows such that each quay crane of said plurality of quay cranes is allocated to a respective crane time window of said plurality of crane time windows; and wherein said operating said at least one quay crane comprises operating each quay crane of said plurality of quay cranes to perform transfer of containers associated with said container carrier during said respective crane time window of said plurality of crane time windows.

Allocating and/or operating several quay cranes is advantageous, since it allows a faster completion of the container carrier berth and, consequently, the container carrier may reduce is cruising speed towards its next container terminal to reduce emission of greenhouse gasses. Further, allocating and/or operating several quay cranes allows a reduction of delivery time of goods to consumers and production facilities.

Further, allocating several quay cranes to several different crane time windows allows for a large degree of flexibility in a container carrier terminal, such that quay cranes may dynamically switch among performing transfer of containers at different container carriers to utilize quay cranes optimally, which is advantageous.

In an embodiment of the invention, said allocating said at least one quay crane is performed from 2 days to 60 days prior to said container carrier berth, such as from 3 days to 30 days, for example from 4 days to 20 days, for example 7 days or 14 days.

Allocating at least one quay crane well ahead of the actual container carrier berth is advantageous, since it allows better planning of operation of the container carrier and container carrier terminal. E.g., better planning may allow the duration of the container carrier berth to be reduced, which in turn may reduce delivery time of goods and emission of greenhouse gases.

In some embodiments of the invention, allocating at least one quay crane to a crane time window includes a having a safety margin within in the crane time window, such that the crane time window is actually of a slightly longer duration than what is required to load, unload, and redistribute containers of the container carrier berth. This reduces the risk of allocating a quay crane in a crane time window which is too short compared to the actual container-related berth workload.

In an embodiment of the invention, said step of allocating said at least one quay crane to said crane time window on the basis of said estimated container-related berth workload, involves calculating a theoretical required number of cranes NCt by a formula corresponding to:

NCt=WLe/(Tb*Pc)

wherein WLe is said estimated container-related berth workload, Tb is said expected duration of said container carrier berth, and Pc is a measure of average crane productivity.

From an estimated container-related berth workload WLe to be handled at a terminal with an average crane productivity Pc during a scheduled berth with an expected berth duration Tb, one of the possible solutions may be calculated by first calculating the theoretically required number of cranes NCt. From this number, several solutions of feasible allocations of cranes may be derived.

In an embodiment of the invention, said step of allocating said at least one quay crane to said crane time window on the basis of said estimated container-related berth workload, involves calculating a theoretical required number of cranes NCt, rounding said theoretical required number of cranes NCt up to an integer number of cranes NC.

The calculated theoretical number of cranes NCt may be a non-integer. One possible solution for the allocation is then to round NCt up to the nearest higher integer to get an integer number of cranes NC to allocate.

In an embodiment of the invention, said step of allocating said at least one quay crane to said crane time window on the basis of said estimated container-related berth workload, involves calculating a required average length of crane time windows Tc from a number of cranes NC by the formula:

Tc=WLe/(NC*Pc)

wherein WLe is said estimated container-related berth workload, NC is said number of cranes, preferably derived from a theoretically required number of cranes NCt, and Pc is a measure of average crane productivity.

Solutions for the allocation can be found by calculating different crane time window lengths if more than one crane is allocated, or reduce the common crane time window for all the allocated cranes. For example, starting from an actual number of cranes NC achieved by rounding a theoretical number NCt up, the required average length of the crane time windows Tc, which will be shorter than the berth duration Tb, may be found.

Other possible allocation solutions involve allocating even more cranes and reduce the lengths of the crane time windows commonly or individually. The formula above can also be used to find the resulting average crane time windows required when increasing the number of cranes NC.

In more advanced embodiments non-productive time such as idle time, crane preparing time, buffer time, inspection time, etc., may be taken into account to result in the number of cranes multiplied by the length of their respective crane time windows and their respective productivity exceeding the estimated workload by an amount corresponding to the various added non-productive time.

In an embodiment of the invention, said estimated container-related berth workload is indicative of a cargo capacity to be unloaded from said container carrier to said container carrier terminal during said container carrier berth.

In an embodiment of the invention, said estimated container-related berth workload is indicative of a cargo capacity to be loaded from said container carrier terminal to said container carrier during said container carrier berth.

In an embodiment of the invention, said estimated container-related berth workload is indicative of a cargo capacity to be redistributed on said container carrier during said container carrier berth.

A cargo capacity may for example be understood as a number of containers or be parameterized by a unit of cargo capacity such as TEU.

Two typical tasks of a quay crane in relation to a container carrier berth is to unload containers from the container carrier to the container carrier terminal, and load containers from the container carrier terminal to the container carrier. Additionally, a quay crane may also redistribute containers on the container carrier, since otherwise some containers may be inaccessible or a weight distribution on the container carrier may be imbalanced. Unloading and loading may typically be performed from/to a quay and/or yard of the container carrier terminal.

From an estimated cargo capacity to be handled at the terminal during a scheduled berth, the allocation step involves determining a suitable combination of number of cranes and length of crane time window which allows for handling the estimated cargo capacity preferably within the expected duration of the scheduled berth. By specification of the general formula above, the estimated cargo capacity WLcc to be handled divided by the expected duration Tb of the scheduled berth and further divided by the average productivity in cargo capacity per crane Pc, cc gives the theoretically required number of cranes NCt:

NCt=WLcc/(Tb*Pc,cc)

For example with cargo capacity of 600 TEU, berth duration of 4 hours and average productivity of 40 TEU/h per crane:

NCt=600/(4*40)=3.75 cranes.

This number could either be rounded up to an allocation of 4 cranes which also provides some buffer time for unforeseen or non-productive events, or be fine-tuned by allocating different crane time windows for each crane, e.g. only allocating 3 hours for one of the cranes, and 4 hours for the other three cranes.

Having the estimated container-related berth workload being indicative of the cargo capacity to be unloaded, loaded, and/or redistributed is advantageous, since these tasks are typical tasks of quay cranes, and estimating these numbers thus allows optimum scheduling of quay cranes, which in turn may reduce delivery time of goods and emission of greenhouse gases.

In an embodiment of the invention, said estimated container-related berth workload is indicative of a number of containers to be moved in relation to said container carrier berth.

A number of containers to be moved, also referred to as container moves or simply moves, may for example be understood as the sum of the number of containers to be unloaded, the number of containers to be loaded, and the number of containers to be redistributed. The parameter may also be given as a separate number for each type of move, i.e. load, unload and redistribution.

From an estimated number of containers to be moved at the terminal during a scheduled berth, the allocation step involves determining a suitable combination of number of cranes and length of crane time window which allows for handling the estimated container moves preferably within the expected duration of the scheduled berth. For example, the estimated container moves WLm to be handled divided by the expected duration Tb of the scheduled berth and further divided by the average productivity given in moves per crane Pc,m, such as the common measure Gross Moves Per Hour, GMPH, gives the theoretically required number of cranes NCt:

NCt=WLm/(Tb*Pc,m)

For example, with estimated workload of 500 container moves, berth duration of 6 hours and average productivity GMPH of 30 moves/h per crane:

NCt=500/(6*30)=2.78 cranes.

This could either be rounded up to an allocation of 3 cranes which also provides some buffer time for unforeseen or non-productive events, or be fine-tuned by allocating different crane time windows for each crane.

For example, by applying the formula Tc=WLe/(NC*Pc) discussed above, the required average crane time window Tc if allocating 4 cranes instead of 3 to the scheduled berth can be calculated:

Tc=500/(4*30)=4.17 hours=4 hours and 10 minutes,

i.e. a considerably shorter time than the scheduled berth duration Tb of 6 hours.

Having the estimated container-related berth workload being indicative of the number of containers to be moved is advantageous, since estimating this number allows optimal scheduling of quay cranes, which in turn may reduce delivery time of goods and emission of greenhouse gases.

In an embodiment of the invention, said estimated container-related berth workload is indicative of a number of crane moves to be performed in relation to said container carrier berth.

Some quay cranes are able to pick up and move more than one container at a time. A quay crane may for example move two containers at a time, or four containers at a time. The number of crane moves may thus be lower than the number of containers to be moved, since one crane move may move more than one container.

Having the estimated container-related berth workload being indicative of the number of crane moves to be performed is advantageous, since estimating this number allows better scheduling of quay cranes, which in turn may reduce delivery time of goods and emission of greenhouse gases.

Note that during a container carrier berth, a quay crane may alternate between loading and unloading containers to maximize utilization of the crane moves. In some embodiments of the invention, such optimized crane moves may be taken into account in the estimated container-related berth workload, whereas in other embodiments it may not.

In an embodiment of the invention, said estimated container-related berth workload is indicative of a number of quay crane workhours required during said container carrier berth.

A number of quay crane workhours is not restricted to natural numbers of mathematics but may be any type of number, e.g. a number including decimals and/or a fraction. Some examples of quay crane workhours are 2.5 hours, 3 hours and 43 minutes, and 7/3 hours. From a number of estimated required quay crane workhours, the allocation step may involve determining a suitable combination of number of cranes and length of crane time window which provides for the estimated quay crane workhours. For example, the estimated crane workhours WLwh required divided by the expected berth duration Tb gives the theoretically required number of cranes NCt:

NCt=WLwh/Tb

This value can be rounded up to an integer to arrive at a possible allocation solution, and other solutions be calculated by adjusting the crane time windows for individual cranes, or use a higher number of cranes.

Having the estimated container-related berth workload being indicative of a number of crane workhours is advantageous, since estimating a number of workhours allows improved scheduling of quay cranes, which in turn may reduce delivery time of goods and emission of greenhouse gases.

In an embodiment of the invention, said estimated container-related berth workload is indicative of a container location distribution onboard said container carrier.

The container location distribution onboard a container carrier may in some cases be important for quay crane operations during a container carrier berth. It may for example determine whether it is necessary to move containers to access containers to be unloaded, whether multiple containers can be picked up at a time be a quay crane, and/or how many quay cranes can access containers to be unloaded at a time.

Having the estimated container-related berth workload being indicative of a container location distribution is advantageous, since estimating container location distribution allows enhanced scheduling of quay cranes, which in turn may reduce delivery time of goods and emission of greenhouse gases.

In an embodiment of the invention, said estimated container-related berth workload is indicative of a container weight.

In an embodiment of the invention, said estimated container-related berth workload is indicative of a number of empty containers.

Empty containers and heavy containers may typically require to be handled differently than regular containers during container carrier berth. They may for example require to be moved or stored differently.

As such, estimating information relating to container weight and number of empty containers is advantageous, since it enables a more detailed quay crane allocation.

In an embodiment of the invention, said container carrier entry is a digital representation of said scheduled container carrier berth.

The container carrier entry may be a data record comprising information about an expected future container carrier berth, also sometimes referred to as a port call.

In an embodiment of the invention, said container carrier entry is linked to said static carrier information.

In an embodiment of the invention, said container carrier entry is associated with a tentative arrival time of said container carrier.

In an embodiment of the invention, said container carrier entry is associated with a tentative departure time of said container carrier.

In an embodiment of the invention, said container carrier entry is linked to said estimated container-related berth workload.

In an embodiment of the invention, said container carrier entry is linked to said crane time window.

Having the container carrier entry linked to or associated with any of a tentative arrival time, a tentative departure time, an estimated container-related berth workload and a crane time window, since providing a combined source of relevant information grants a user a better overview and thus enables improved planning and resource allocation.

The links and associations between various data records and information may preferably be implemented by means of a relational database structure, object-oriented data structure, or other suitable data structures.

The expected duration of the container carrier berth may be understood as the duration from the tentative arrival time to the tentative departure time.

In an embodiment of the invention, said method comprises a step of receiving a declared container-related berth workload from said container carrier after allocating said at least one quay crane.

In an embodiment of the invention, said method comprises a step of modifying said crane time window based on said declared container-related berth workload.

A few days, for example 2 days, before the container carrier berth, a communication typically takes place between the container carrier and the container carrier terminal. For example, a manager/captain of the container carrier may provide a declared container-related berth workload to the container carrier terminal, e.g. a captain may declare a number of containers to be unloaded.

Receiving a declared container-related berth workload, and optionally modifying the crane time window on the basis thereof, is advantageous, since it enables confirming the validity of or making adjustments to the crane time window leading to a more efficient container carrier berth, which in turn may reduce delivery time of goods and emission of greenhouse gases.

In an embodiment of the invention, said method comprises a step of rescheduling said container carrier berth based on said crane time window.

In an embodiment of the invention, said rescheduling said container carrier berth is based on a correspondence between said container carrier terminal and said container carrier.

For example, if the duration of the crane time window is different than the scheduled duration of the container carrier berth, it is advantageous to reschedule the container carrier berth to better match the crane time window. For example, if the start of the crane time window is earlier than the scheduled container carrier berth then rescheduling the container carrier berth accordingly ensures delivery of goods, if the start of the crane time window is later than the scheduled container carrier berth then rescheduling the container carrier berth accordingly ensures reduced emission of greenhouse gases, if the end of the crane time window is later than the end of the scheduled container carrier berth then rescheduling the container carrier berth accordingly ensures delivery of goods, and if the end of the crane time window is earlier than the end of the scheduled container carrier berth then rescheduling the container carrier berth accordingly ensures reduced emission of greenhouse gases.

Rescheduling the container carrier berth may also be based on a plurality of crane time windows of a plurality of quay cranes.

Rescheduling may typically involve a correspondence and an agreement between the container carrier terminal and the container carrier or a representative thereof, by rescheduling a container carrier berth is not restricted to any particular means.

Rescheduling may for example be understood as changing a tentative arrival time or changing a tentative departure time of the container carrier.

In an embodiment of the invention, said method comprises a step of rescheduling an auxiliary container carrier berth based on said crane time window.

Since some container carrier terminals facilitate many simultaneous container carrier berths of many container carriers in which many quay cranes are dynamically switching between different carrier berths, an allocated crane time window of one crane and associated with a container carrier berth may easily impact the capacity of the container carrier terminal to handle another container carrier berth, i.e. an auxiliary container carrier berth.

Rescheduling an auxiliary container carrier berth may ensure delivery of goods, may lead to faster delivery of goods, and/or may reduce emission of greenhouse gases.

In an embodiment of the invention, said generating said estimated container-related berth workload is based on a workload predictor.

Having an, at least partially, dedicated appliance or engine for generating the estimated container-related berth workload is advantageous, since it allows this appliance or engine to be allocated and/or connected to any entity which may require an estimated container-related berth workload.

A workload predictor may for example be computer implemented.

In an embodiment of the invention, said generating said estimated container-related berth workload is performed by a workload predictor executed by data processing equipment.

A workload predictor, also referred to as workload estimator, may advantageously be implemented in a computer system, preferably the container carrier terminal system, to perform the estimation of a container-related berth workload for a scheduled berth.

The workload predictor may comprise executable implementations of algorithms, mathematical functions, lookup tables, artificial intelligence, etc., arranged to estimate container-related berth workload from static carrier information.

In an example, the workload predictor may be arranged to calculate an average workload WLa over the past 12 months for workloads WLbn of past berths Bn−1, Bn−2, . . . Bn−12 of a certain container carrier carrier_id visiting the terminal each month and provide this average as an estimate WLe of the workload for the next berth Bn of this certain container carrier, e.g.:

WLe(carrier_id,n)=WLa(carrier_id)=ΣWLbn−i/12, i=1 . . . 12.

In another example, the workload predictor may comprise a lookup table where historical data have been aggregated and grouped according to container carrier vessel size categories and time of year, and the workload predictor provides an estimate workload for a certain berth by looking up the container carrier vessel class and date in the table and reading the associated workload estimate. The look-up table may for example resemble the following, with the estimated workloads referring to estimated TEU capacity to be unloaded/loaded/redistributed:

| Season\Size | Panamax | Post-Panamax | New Panamax | ULCV |
|---|---|---|---|---|
| Spring | 250 | 425 | 900 | 1,300 |
| Summer | 150 | 200 | 500 | 900 |
| Fall | 300 | 500 | 1,000 | 1,500 |
| Winter | 200 | 350 | 700 | 1,100 |

In another example, the workload predictor may be arranged to perform an exponentially weighted moving average function implemented as an infinite impulse response (IIR) filter configured to average the number of container moves WLm,a required at each berth in a certain terminal by a certain shipping route or other relevant grouping, store this average WLm,a(old) for each group, update the average based on actual container moves WLm at the most recent berth in that group to obtain WLm,a(new), and use the newest average of a relevant group for estimating a number of container moves WLm,e of a scheduled berth, identifying the relevant group from static carrier information related to the scheduled berth, such as the shipping route. For example by the following formula which both updates the average with the most recent actual value and provides the new estimate for the next berth, and where 0<α<1 is a smoothing factor where increasing a increases emphasis on recent values:

WLm,e=WLm,a(new)=α*WLm+(1−α)*WLm,a(old)

In another example, the workload predictor may include a mathematical model of patterns among past workloads, the mathematical model being generated by machine learning applied by the workload predictor or elsewhere arranged to perform pattern recognition or classification among training data encompassing a historical berth database, and is arranged to use the mathematical model to predict a workload for a future berth based on static carrier information including one or more of for example container carrier name, type, time of year, shipping route, shipping company, etc.

In an embodiment of the invention, said workload predictor is associated with a workload prediction algorithm.

An algorithm, e.g. a computer-implemented algorithm, is well-suited for generating the estimated container-related berth workload. An algorithm can for example rapidly search databases such as a historical search database, process data, search lookup tables such as a berth lookup table, perform calculations, perform automated reasoning, or any combination of these.

A workload prediction algorithm according to the invention may be any type of algorithm which is able to, at least partially, participate in generating an estimated container-related berth workload.

Using a workload prediction algorithm is advantageous, since it enables complex calculations and problem solving to be implemented to quickly provide a precise and accurate estimated container-related berth workload, which in turn may result in reduced delivery time of goods and reduced emission of greenhouse gases.

In an embodiment of the invention, said static carrier information represent one or more of the following: a container carrier identifier, a container carrier type, a container carrier manager, a container carrier size, and a container carrier volume.

A container carrier identifier may be understood as name or a tag which identifies the container carrier. Examples of container carrier identifiers are container carrier name, optionally including a ship prefix based on the type of ship, a serial code, an alphanumeric ID. A container carrier identifier may be permanent for a container carrier while others may be changes, e.g. by a manager of the container carrier, or by a manager of a terminal.

A container carrier type may for example be related to a class of the container carrier or a size category. Examples of size categories are Small Feeder, Feeder, Feedermax, Panamax, Post-Panamax, New Panamax, and Ultra Large Container Vessel, ULCV. Examples of classes are Maersk Triple E class, COSCO Guangzhou class, Explorer class, and Bay class.

A container carrier manager may for example be a shipping company related to the container carrier. A specific shipping company may, for example, systematically require a small (or large) number of containers to be unloaded, making the container carrier manager a technically relevant parameter for generating an estimated container-related berth workload.

A container carrier size may for example be indicative of length, height, width, beam, weight, and/or draft.

A carrier container volume may for example be indicative of its maximum capacity of containers. For example, a container volume may be 18,270 TEU.

A static carrier identifier according to the invention may be approximate, e.g. related to an interval. For example, a static carrier identifier may be a container carrier length from 250 meters to 300 meters or a carrier container volume from 10,000 TEU to 14,500 TEU. For example, in an embodiment of the invention, any incoming container carrier is binned into one of several carrier container volume intervals, and an estimated container-related berth workload is generated for each container carrier based on which carrier container volume interval it lies within.

Using a representation of one or more of container carrier identifier, container carrier type, container carrier manager, container carrier size, and carrier container volume as static carrier information is advantageous, since these various parameters are indicative of the number of containers which the container carrier may transport, and thus indicative of how large the actual container-related berth workload is.

In an embodiment of the invention, said estimated container-related berth workload is based on container carrier route information.

It is not uncommon that several container carriers sail the same route and visit the same container carrier terminals to ensure a regular flow of goods. Such container carriers may be more likely to have similar actual container-related berth workloads. Thus, using container carrier route information to generate an estimated container-related berth workload may improve the accuracy of the estimate, which in turn may yield a more precise crane time window, which in turn may ensure delivery of goods, reduce delivery time of goods, and/or reduce emission of greenhouse gases.

Container carrier route information may for example relate to a container carrier route identifier, a geographical route, information relating to other terminals on the route, and/or information relating to other container carriers sailing the same route.

Typically, container carrier route information may be indicative of at least some static carrier information. E.g. a certain container carrier route may be associated with a certain group of container carriers and/or a certain container carrier type. As such, in some embodiments of the invention, static carrier information according to the invention may be supplied and used indirectly for generating an estimated container-related berth workload, e.g. as part of the carrier route information. Static carrier information may thereby also be understood as container carrier route information, also referred to as static route information.

In an embodiment of the invention, said estimated container-related berth workload is based on auxiliary container carrier route information.

When containers are transported between different container carrier terminals, they may require transport by multiple container carriers, e.g. a container which requires transport from a first container carrier terminal to a second container carrier terminal may first be transported by a first container carrier from the first container carrier terminal to a third container carrier terminal, and second be transported by a second container carrier from the third container carrier terminal to the second container carrier terminal. Such containers, which are to be temporarily stored in a container terminal between transport on two different terminal carriers may for example be referred to as connecting cargo. The two container carriers which are involved with transporting the connecting cargo may typically be associated with different container carrier routes. A connection between two different container carrier routes to facilitate transportation of connecting cargo may be referred to as a transshipment connection.

As such, shipping of containers on one container carrier route can often depend on shipping of containers on another route. As such, basing the estimated container-related berth workload on auxiliary container carrier route information, i.e. information relating to another container carrier route than the container carrier route of the container carrier, may provide a more accurate and/or precise estimate of the container-related berth workload, which is advantageous since it may further ensure delivery of goods, decrease delivery time of goods, and to reduce emission of greenhouse gases.

In an embodiment of the invention, said estimated container-related berth workload is based on a container storage volume of said container carrier terminal.

A container storage volume may be understood as a measure of cargo at the terminal. For example, a number of containers/units of TEU on the terminal. The container storage volume may for example be a current storage volume, or an estimated future storage volume, e.g. the number of containers estimated to be stored at the container carrier terminal at the arrival of the container carrier.

A container storage volume may further refer to a storage volume related to a subset of the full storage volume. For example, a particular section of the storage/yard of the container carrier terminal may be at least partially dedicated to containers of a container carrier route relevant for the container carrier, and therefore it is preferable to base the estimated container-related berth workload on the container storage volume of this particular section.

Basing the estimated container-related berth workload on a container storage volume is advantageous, since the container storage volume may be indicative of the estimated container-related berth workload.

In an embodiment of the invention, said estimated container-related berth workload is partially based on a contractual container-related berth workload.

In an embodiment of the invention, said estimated container-related berth workload is based on a multiplication factor.

In an embodiment of the invention, said estimated container-related berth workload is based on an addition factor.

Basing the estimated container-related berth workload on the contractual container-related berth workload is advantageous, since the contractual container-related berth workload may to some degree be indicative of the actual container-related berth workload. In an example, the actual container-related berth workload for a certain container carrier in a specific terminal was calculated based on empirical data to typically be from 60 percent to 80 percent of the contractual container-related berth workload, and an estimated container-related berth workload may thus be generated by applying a multiplication factor of 0.7 to the contractual container-related berth workload. In another example, the actual container-related berth workload for a certain container shipping route in a specific terminal was calculated based on empirical data to typically involve unloading of an additional cargo capacity from 300 TEU to 500 TEU more than the contractual container-related berth workload, and an estimated container-related berth workload may thus be generated by applying an addition factor of 400 TEU to the contractual container-related berth workload. In both examples, an allocation of cranes based on the estimated workload instead of no allocation or allocation based on the pro-forma contracts, achieves in general a better performance at the time of operation.

Note that an addition factor may be negative, e.g. if the actual container-related berth workload is expected to be smaller than the contractual container-related berth workload.

In some embodiments, generating an estimated container-related berth workload may typically require more mathematical operations than a single multiplication and/or a single addition.

Any multiplication factor, addition factor, or other factor involved in generating the estimated container-related berth workload may be variable. For example, a factor may depend on season of the year and/or static carrier information.

In an embodiment of the invention, said estimated container-related berth workload is based on berth lookup table.

A berth lookup table may for example operate in combination with static carrier information and/or container carrier route information. A berth lookup table may for example be based on container carrier identifier, container carrier type, shipping company, container carrier size, and/or container carrier volume.

A berth lookup table may be understood as a lookup table, e.g. an array or table of information indicative of actual container-related berth workloads or estimated container-related berth workloads, for example relating to static carrier information. For example, each container carrier type may have an entry with an associated cargo capacity in the berth lookup table, and upon scheduling of a container carrier berth of a container carrier, the container carrier type of that container carrier may be used in comparison with the berth lookup table to find the entry of that container carrier type and use the associated cargo capacity as the estimated container-related berth workload.

Basing the estimated container-related berth workload on a berth lookup table is advantageous, since it is easy to implement, update, understand, and access for the user. The berth lookup table may for example be computer implemented.

In an embodiment of the invention, said estimated container-related berth workload is based on a prediction of loading and unloading of containers of said container carrier at auxiliary container carrier terminals.

For example, a carrier may be scheduled to perform container carrier berth at two auxiliary container carrier terminals before berthing at the container carrier terminal, and in this example, a current tentative number of containers of the container carrier in combination with predictions of container to be loaded and unloaded at the auxiliary container carrier terminals may be used to establish an accurate estimated container-related berth workload, which is advantageous.

In an embodiment of the invention, said generating an estimated container-related berth workload is partially based on user input.

For example, a computer implemented container carrier terminal system may provide an estimated container-related berth workload, which an experienced user may use as basis for providing a more precise user-established estimated container-related berth workload, e.g. based on the experience and/or knowledge of the user, which is advantageous.

In an embodiment of the invention, said generating said estimated container-related berth workload is based on a historical berth database.

In an embodiment of the invention, said historical berth database comprises one or more past container carrier berth representations or aggregation thereof.

The past container carrier berth representations may be any container carrier berth of the past associated with any container carrier and any container carrier terminal. The historical berth database may thus comprise any past container carrier berth representations of all container carrier berths of the past, or aggregations thereof. However, in practice, accessibility to such data may be restricted. In practice, a historical database may comprise representations or aggregations of only a subset of past container carrier berths. This may for example be past container carrier berth representations based on specific container carrier terminals, container carriers, container carrier types, shipping companies, container carrier routes etc. A historical berth database may further comprise information relating to time of year and time of day, prominent world or local events, etc. Further, a historical berth database may comprise information relating to past shipping conditions, e.g. information relating to the magnitude of past flow of containers through supply chains, a past number of container carriers, a past number of container carrier terminals etc. However, note that a historical berth database according to the invention is not restricted to any particular information, extent of information, or type of database.

A historical berth database is an advantageous basis with empiric data for generating an accurate and precise estimated container-related berth workload, which is advantageous.

Further, a historical berth database may provide new insights to container terminal carrier management in general, which may further increase efficiency, resulting in reduced delivery time of goods and reduced emission of greenhouse gases.

In an embodiment of the invention, each of said past container carrier berth representations comprises a representation of a past container-related berth workload of said past container carrier berth event.

A past container-related berth workload may be indicative of an actual container-related berth workload of a scheduled container carrier berth. Using past container-related berth workloads as a basis for an estimated container-related berth workload may thus be more accurate and/or precise which is advantageous. The past container-related berth workload may for example include the actual amount of containers which were unloaded, loaded and redistributed in a specific terminal at each berth. In various embodiments, the information may also include the total duration of the loading/unloading/redistribution operations and number of allocated cranes at that instance, the experienced terminal efficiency, the specific crane identifiers, the weather conditions, etc., which may be used to further qualify an estimate of the required workload for a future container-related berth under similar or different conditions.

In an embodiment of the invention, each of said past container carrier berth representations comprises a representation of past static carrier information of said past container carrier berth event.

In an embodiment of the invention, said generating said estimated container-related berth workload is based on associating said static carrier information with said past static carrier information.

By comparison of static carrier information with past static carrier information, it is possible to directly compare the container carrier berth with past container carrier berths. This may yield a more precise and/or accurate estimated container-related berth workload, which is advantageous.

As such, the past static carrier information may typically represent any of the same type of information as the static carrier information.

In an embodiment of the invention, said workload predictor is linked to said historical berth database.

In an embodiment of the invention, said workload prediction algorithm is based on computational statistics wherein said historical berth database is used as a statistical database for said computational statistics.

In an embodiment of the invention, said workload prediction algorithm is based on machine learning and wherein said historical berth database is a training dataset used for said machine learning.

Machine learning may be understood as improvement of algorithms or computer models through experience. Machine learning typically requires a training dataset, which the algorithm to be trained may use to gain experience. As such, an algorithm can be enhanced to make more accurate predictions/estimates and/or make better decisions. As such, machine learning may be considered related to computational statistics which focuses on making predictions using computers.

Many different types of machine learning algorithms exist, such as supervised learning, unsupervised learning, semi-supervised learning, reinforcement learning, self learning, feature learning, sparse dictionary learning, anomaly detection, robot, learning, association rules etc.

Performing machine learning often involves creating a model, which is trained on training data, e.g. the historical berth database, and which can then process additional data to make predictions, e.g. the estimated container-related berth workload. Examples of models are artificial neural networks, decision trees, support vector machines, regression analysis, Bayesian networks, genetic algorithms etc.

Note that the workload prediction algorithm according to the invention is not restricted to any particular type of machine learning and model and may be implemented in any manner by a skilled person, within the scope of the claims.

In some embodiments of the invention, the workload prediction algorithm may be considered a type of artificial intelligence.

In some embodiments of the invention, the estimated container-related berth workload may be indirectly based on the historical berth database. For example, a container carrier terminal system used for generating an estimated container-related berth workload may be linked to a workload prediction algorithm which provides the estimated container-related berth workload, where the historical berth database has been used as a training dataset for machine learning of the workload prediction algorithm, while the container carrier terminal system cannot access the historical berth database itself.

Basing a workload prediction algorithm on computational statistics or machine learning is advantageous, since these types of methods are able to provide improved predictions/estimates and/or make better decisions, which in this context may correspond to generating a more accurate and precise estimated container-related berth workload, which in turn may result in reduced delivery time of goods and/or reduced emission of greenhouse gases.

In an embodiment of the invention, said berth lookup table is based said historical berth database.

Generating and/or updated the berth lookup table based on the historical berth database is advantageous, since the historical berth database may be indicative of an actual container-related berth workload, and, consequently, this may result in reduced delivery time of goods and reduced emission of greenhouse gases.

In an embodiment of the invention, said method comprises a step of deriving an actual container-related berth workload and supplying a representation of said actual container-related berth workload to said historical berth database to establish an additional past container carrier berth representation of said one or more past container carrier berth representations.

An actual container-related berth workload is indicative of the actual transfer of containers performed by quay cranes in relation to the container carrier berth. It may for example be the number of containers moved, the number of TEU moved, or the number of quay crane workhours spend.

The actual container-related berth workload may for example be derived based on automatically obtained data, or manually obtained data.

Supplying a representation of the actual container-related berth workload to the historical berth database is advantageous, since adding more data to the historical berth database may in turn improve the method and/or knowledge of operation of the container carrier terminal. For example, it may be used to update a berth lookup table or to improve a workload prediction algorithm.

In an embodiment of the invention, said actual container-related berth workload is based on said declared container-related berth workload.

The actual container-related berth workload may often be approximately or identical to the declared container-related berth workload. Thus, using the declared container-related berth workload is advantageous, since it is a simple approach to update the historical berth database.

In an embodiment of the invention, said actual container-related berth workload is based on a recorded container-related berth workload which has been recorded in relation to said container carrier berth.

In an embodiment of the invention, said actual container-related berth workload is based on a recorded container-related berth workload which has been recorded in relation to said operating said at least one quay crane.

Recorded data may for example be provided by containers and/or quay cranes. Any of these may for example be associated with devices for measuring transfer of containers.

Providing a recorded container-related berth workload as basis for an actual container-related berth workload is advantageous, since a recorded container-related berth workload may be an accurate and/or precise representation of the actual container-related berth workload.

In an embodiment of the invention, said further method comprises:

providing, in said container carrier terminal system (7), a model of said container carrier terminal (2) executed on data processing equipment (18), said model comprising representations of terminal resources and terminal constraints relating to said terminal resources, wherein said terminal resources comprise said at least one quay crane (1) and said representations of terminal resources including representations of said at last one quay crane (1); and

inputting, in said container carrier terminal system (7), a plurality of said container carrier entries (6), each container carrier entry (6) relating to a container carrier (3) and associated with a preliminary terminal resource demand including said estimated container-related berth workload (8).

In the present disclosure, a “model” is understood as a computer-implemented representation of the container carrier terminal. The model may comprise various representations of container carrier terminal resources and container carrier terminal constraints, which in the below is referred to as terminal resources and terminal constraints respectively. By modeling the terminal resources and terminal constraints of the container carrier terminal it may be possible by use of the model to allocate terminal resources to container carriers before the container carriers arrive at the container carrier terminal.

In the present disclosure, “a terminal resource” is understood as a deployable asset, such as quay cranes, of the container carrier terminal which serves in the operation of the container carrier terminal, such as in loading/unloading of shipping containers to/from container carriers berthing at the container carrier terminal. The terminal resources comprise among others the at least one quay crane to be operated and/or allocated. The terminal resources may for example comprise:
Pilots—By a “pilot” is understood a person who maneuvers ships through dangerous or congested waters, such as harbors or river mouths. The pilot is a navigational expert possessing knowledge of the particular waterway such as its depth, currents, and hazards. The pilot may thus be experienced in maneuvering a container carrier through the waterways surrounding the container carrier terminal and safely berth the ship at a position along a quay of the container carrier terminal. The pilot may also be referred to as a maritime pilot, marine pilot, harbor pilot, port pilot or a ship pilot.
Tugboats—By a “tugpilot” is understood any kind of vessel that maneuvers other vessels by pushing or pulling them either by direct contact or by means of a tow line. Tugboats typically move vessels, such as container carriers in or at a container carrier terminal, that are restricted in their ability to maneuver on their own.
Quay length—By a “quay length” is understood a length of section of a quay of a container carrier terminal or a length of an entire quay of a container carrier terminal. By a quay is understood a structure on the shore-side of a container carrier terminal where container carriers may dock/berth to load and unload shipping containers. A container carrier terminal may comprise one or more quays. A quay length may further be understood as a section of a quay, having a length, and which may be allocated to container carriers. As an example, a container carrier may have a length of 398 meters, and therefore at least a quay length, or quay section, of 398 meters must be allocated in order to berth the container carrier at the container carrier terminal. In practice a quay length of more than 398 meters may be allocated in order to make room for maneuvering of the container carrier during berthing at the terminal, and also an additional safety distance between container carriers may be required.
Bollards—By a “bollard” is understood any kind of structure capable of anchoring a container carrier at a quay. The bollards may be distributed along the quay and may also define specific berthing positions along the quay where container carriers may berth.
Quay cranes—By a “quay crane” is understood as a quayside (or dockside) crane for loading/unloading shipping containers to/from container carriers. The quay crane may therefore also be referred to as a ship-to-shore crane. The quay crane may be configured to move along rail tracks along a quay side of the container carrier terminal such that the quay crane may be positioned at necessary positions relative to the berthing container carrier for the loading/unloading of shipping containers. The quay crane may be operated by a dedicated gang of workers or alternatively be an automatically operated quay crane, e.g. an autonomous quay crane. The quay crane comprises a crane boom for reaching in over a berthing carrier to perform loading/unloading operations of shipping containers. The boom may be hinged to allow passage of large container carriers beneath or it may be fixed to reduce airspace being taken up.
Prime movers—By a “prime mover” is understood any kind of vehicle capable of transporting a shipping container from one place to another at the container carrier terminal. The prime mover may be a terminal truck. As an example, the prime mover may be a manually operated terminal truck or a fully autonomous terminal truck.
Straddle carrier—By a “straddle carrier” is understood a container-carrying vehicle that carries its load underneath by “straddling” it, rather than carrying it on top like a conventional truck. The straddle carrier is able to load and unload containers without the assistance of cranes or forklifts. As an example, the straddle carrier may be a manually operated or be fully autonomous.
Stacking crane—By a “stacking crane” is understood a gantry-like crane arranged to lift shipping containers and place/stack the containers at various positions and heights at the yard. The stacking crane may move around on the yard of the container carrier terminal by moving along rails.
Gangs—By a “gang” is understood a unit of workers which together as a team perform an operation relating to loading/unloading of shipping containers. The gang may be a dedicated quay crane gang specifically trained for operating a quay crane, e.g. a specific quay crane of a container carrier terminal. The gangs may work in shifts of e.g. 8 hours

In the present disclosure, a “terminal constraint” may be understood as an operational constraint of the container carrier terminal. The terminal constraint may thus comprise constraints relating to the deployment of terminal resources; however, the terminal constraints may also relate to physical constraints/restrictions of the container carrier terminal such as the physical layout of the container carrier terminal. The terminal constraints comprise among others the crane allocation constraints related to the at least one quay crane to be operated and/or allocated. The terminal constraints may for example comprise:
Quay depth—By “quay depth” is understood the distance between the water level at the quay and the seabed beneath. The quay depth may vary along the length of the quay.
Container carrier terminal entry restrictions—By a “container carrier terminal entry restriction” is understood physical limitations relating to the entry point(s) of the container terminal. As an example, a container carrier berthing at a container carrier terminal may have to sail along very specific sailing routes into the quay due to various hazards in the environment surrounding the terminal or due to depth restrictions. It may be for example that the entry route to the container carrier terminal from sea passes through one or more canals or other width restrictions imposed by the landscape or urban environment surrounding the container carrier terminal, and therefore the entry route may be congested due to the presence of other container carriers. Thus, the container carrier terminal entry restriction may be a time-varying restriction due to congestion of container carriers being dependent on time or even due to tides which over the course of a day may change the availability of the container carrier terminal.
Quay crane maintenance—a quay crane is a vital asset to q container carrier terminal as it performs the key critical operations of the terminal, namely loading, unloading, and/or redistribution of shipping containers. As global container traffic steadily increases the workload of the quay cranes also increases, therefore high utilization rates of quay cranes may be desired. A high utilization rate of a quay cranes puts significant stresses on components of the quay cranes (motors, gears, structural components, etc.), and over time these components may degrade or in the worst case fail to such an extent that operations of the quay crane is no longer possible. Alternatively, a quay crane may have to be upgraded to meet new terminal resource demands imposed by ever increasing in size container carriers. As an example, the quay crane may need to be raised in height to accommodate larger ships, or the boom of the crane may need to be enlarged. In other words, a quay crane will need some kind of maintenance from time to time and such maintenance naturally imposes downtime of the quay crane. Downtime of the quay crane due to maintenance is thus a constraint which have to be complied with in the allocation of terminal resources.
Quay cranes may not cross each other along the quay. Typically, quay cranes are arranged to move on rail-like tracks along the quay, and such a track may service more than one quay crane. In such a situation it is clear that quay cranes cannot pass each other on the same set of tracks.
Quay cranes may only be allocated to container carriers if the reach of the quay crane is sufficient for the container operation required.
Gang availability—when operating a quay crane a gang is typically required. The number of gangs available at any given time may be a bottleneck to the operations of the container carrier terminal. As an example, it may not be possible to allocate all quay cranes of a terminal if there is not enough available gangs. The gang availability may be reflected in gang schedules, such as schedules for dayshifts and nightshifts.

In the present disclosure, a “preliminary terminal resource demand” is understood as demands of the container carrier which the container carrier terminal must strive towards fulfilling through its allocation of terminal resources. As such, the estimated container-related berth workload forms part of the preliminary terminal resource demand. The preliminary terminal resource demand may comprise a certain number of tugboats and/or pilots, the number of shipping containers to be loaded, the number of containers to be unloaded, and the number of containers to be redistributed once the container carrier is berthing at the container carrier terminal. Since a tentative arrival time and departure time of the container carrier is already established prior to its arrival in the terminal, these container-related preliminary resource demands may also be translated into a number of container moves to be performed per unit of time. The preliminary terminal resource demand may also relate to the specifications of the container carrier, i.e. the length, width, height and depth of the container carrier, or a preferred side of berthing, i.e. port side or starboard. As an example, a container carrier having a depth under sea level, i.e. the distance from container carriers keel and the waterline of the container carrier also known as the draft of the container carrier, of 15 meters, the container carrier terminal must be able to provide a section of a quay having a depth surpassing this draft. As suggested by the name, the preliminary terminal resource demand represents a terminal resource demand that may be changed at a later stage. A shipping company operating a container carrier may have a contractual agreement with the container carrier terminal that a certain number of shipping containers are to be loaded/unloaded at the container carrier terminal every time the container carrier is berthing and this may be reflected in the preliminary terminal resource demand. Thus, well in advance of the container carrier berthing at the container carrier terminal there may be an agreement on how many containers to be moved, however, in practice, as the container carrier is on its way from a previous port call to the container carrier terminal for berthing the actual amount of containers to be moved may be known, and this may be a different number from the number in the contractual agreement. Changes between such a present terminal resource demand and a preliminary terminal resource demand may be reflected in an updated terminal resource demand. By an “updated terminal resource demand” is therefore understood the most up-to-date knowledge of the resource demands of a container carrier destined for berth at the container carrier terminal.

In an embodiment of the invention, said container carrier terminal system (7) comprises a plurality of container carrier entries (6) relating to different container carrier berths (4) of different container carriers (3) and each being associated with respective preliminary terminal resource demands and static carrier information (5), said further method comprises:

generating said estimated container-related berth workloads (8) for at least two of said container carrier entries (6) based on said static carrier information (5);

allocating a respective subset of said terminal resources to each of said container carrier entries (6) including said allocation of said at least one quay crane (1) to said crane time window (9) to obtain a preliminary terminal resource plan of allocated terminal resources, wherein said step of allocating terminal resources comprises automatically validating said allocated terminal resources of the container carrier entries (6), the allocated terminal resources including a subset of said at least one quay crane (1), and

wherein the validating includes automatically establishing whether the allocated terminal resources of the container carrier entries (6) comply with said terminal constraints and said preliminary terminal resource demand associated with said plurality of container carrier entries (6).

In the present disclosure, a “preliminary terminal resource plan” is understood as a plan of allocated terminal resources. The plan is preliminary in the sense that the plan is provided on the basis of a distribution of terminal resources complying with preliminary terminal resource demands. The preliminary terminal resource plan may be regarded as a schedule of the terminal resources. For example, the preliminary terminal resource plan may show what quay cranes have been allocated to what container carriers and for which time periods. Furthermore, the preliminary terminal resource plan may also comprise schedules of other terminal resources, such as which quay positions are allocated to which container carriers, i.e. where the container carriers are scheduled to berth at the quay, as well as schedules of gangs such as gangs working on dayshifts and/or nightshifts. As the name suggests, the preliminary terminal resource plan may be updated in the future when updated terminal resource demands are provided.

Besides basing the allocation on the estimated container-related berth workload, it may preferably also be at least partly based on the tentative arrival times of the preliminary terminal resource demands, as it may be advantageous to take the tentative arrival times into consideration when allocating subsets of terminal resources to the container carrier entries. Thereby it may be determined which container carrier entries demand resources at the same time, neighboring times or are not related in time. The consideration of tentative arrival time may preferably be enhanced by also taking into account the expected duration and/or a tentative departure time. In preferred embodiments, the allocation is further based on other preliminary terminal resource demands and/or terminal constraints.

The validating may comprise establishing whether the allocated terminal resources comply with the estimated container-related berth workload and preferably also the tentative arrival times of the preliminary terminal resource demands. In order to evaluate whether the established preliminary terminal resource plan may be problematic with respect to compliance between resources, demands and constraints, it may be advantageous, besides the estimated container-related berth workload, to take into consideration the tentative arrival times comprises by the demands of container carrier entries, thereby making it possible to consider potential problems with the allocation for a specific point in time. For example, it may be possible when taking into account the tentative arrival time, which may be derived from other time values such as tentative departure time, estimated time of arrival, etc., to sum up how many cranes have been allocated for a specific date and time and compare with the total amount of cranes in the terminal.

In the present disclosure, “automatically validating” is understood as a process being carried out in relation to the allocation of terminal resources, for example with each change or group of changes to the updated or preliminary terminal resource plan, or at occurrence of changes in the demands, constraints, or entries, at regular or irregular time intervals, etc. The validation being automatic means that it is computer-implemented and provides a result automatically. The triggering of the automatic validation may be automatic as part of the allocation, for example automatically carried out each time a change occurs, and/or be user-triggerable, e.g. upon a user requesting to validate the current terminal resource plan, or for example triggered by a user interacting with a user interface, e.g. using a user interface to modify demands, constraints, container carrier entries and/or terminal resources.

The automatic validation may for example include establishing whether the allocated resources, e.g. quay cranes, match the demanded resources, e.g. estimated container-related berth workload, e.g. with respect to a tentative arrival time or loading/unloading amount, for each container carrier entry. The automatic validation may for example, in addition or instead, include establishing whether the allocated resources, e.g. quay cranes, match the terminal constraints, e.g. cranes allocation constraints, e.g. with respect to maintenance time slots or crane availability. In case the validation shows mismatch of either demands or constraints with the allocated resources, it may not be possible for the terminal to provide the agreed or expected service to the container carrier, for example unloading an estimated number of containers within an estimated time frame because the allocated number of cranes cannot move that amount of containers in that time frame, or the allocated number of cranes do not exist or are not available on the quay in that time frame.

The automatic allocation and automatic validation may be carried out sequentially, for example performing a validation after the allocation, or performing a new allocation after a validation has indicated challenges with the current plan. The allocation and validation may also be carried out iteratively, in particular when major changes of demands or constraints have been entered and validation of the previous terminal resource plan therefor fails on several accounts. In an embodiment the validation is an integrated part of the allocation so each consideration in the allocation is validated before applied to the plan, or so that all possibilities are validated and the option with best validation result is applied to the plan. In an embodiment, the allocation and validation is carried out regularly to keep the preliminary terminal resource plan up to date. It may be advantageous to allow the allocation step to produce a preliminary terminal resource plan several weeks or months ahead on the basis of what current information and estimation is available, even if the plan will thereby most probably be incomplete and flawed, in order to at least have a direction and preliminary knowledge about future capacity of the terminal, and to have a starting point for fine tuning the plan as better information comes in. In such an embodiment it may further be advantageous to utilize the automatic validation step to determine the quality of the preliminary terminal resource plan in terms of for example feasibility or efficiency, and on the basis of the most current data (demands, constraints, entries) which may be different from the data that the allocation was carried out for.

The automatically validating said allocated terminal resources may be integrated in an automatic distribution step, or an automatic distribution step may be integrated in the automatic validating step. The automatic validating step may thereby also be considered an automatic distribution step.

In an embodiment of the invention a demand may be understood as a request implying requirement of a certain demand for a terminal capacity, e.g. in relation to container moves and berth location, and in this embodiment the validation is automatically performed in relation to the requested capacity and how the terminal resources can actually perform in relation to such requested capacity.

The invention further relates to a container carrier terminal system comprising data processing equipment configured to store a container carrier entry associated with a scheduled container carrier berth of a container carrier at a container carrier terminal comprising at least one quay crane; the container carrier being associated with static carrier information;

characterized in that the container carrier terminal system comprises a workload predictor configured to generate an estimated container-related berth workload associated with said container carrier berth based on said static carrier information; and

the container carrier terminal system being configured to use data processing equipment to perform and store an allocation of said at least one crane to a crane time window which lies at least partially within an expected duration of said container carrier berth, wherein said allocation is performed in said container carrier terminal system prior to said container carrier berth and is based on said estimated container-related berth workload.

In an embodiment of the invention, the container carrier terminal system is further configured to read said stored allocation of said at least one crane and operate said at least one quay crane to perform transfer of containers associated with said container carrier during said crane time window.

In an embodiment of the invention, said container carrier terminal system comprises a model of said container carrier terminal executed on data processing equipment, said model comprising representations of terminal resources and terminal constraints relating to said terminal resources, said representations of terminal resources including representations of said at least one quay crane; wherein said container carrier entry is associated with a preliminary terminal resource demand including said estimated container-related berth workload.

In an embodiment of the invention, said container carrier terminal system comprises a plurality of container carrier entries relating to different container carrier berths of different container carriers and each being associated with respective preliminary terminal resource demands and static carrier information, and wherein said at least one quay crane comprises a plurality of quay cranes;

wherein the container carrier terminal system is configured to generate estimated container-related berth workloads for at least two of said container carrier entries based on said static carrier information; and

wherein the container carrier terminal system is configured to allocating a respective subset of said terminal resources to each of said container carrier entries including said allocation of said at least one quay crane to said crane time window to obtain a preliminary terminal resource plan of allocated terminal resources.

In an embodiment of the invention, said allocating terminal resources comprises automatically distributing terminal resources, including said plurality of quay cranes, to said plurality of container carrier entries to comply with said terminal constraints and said preliminary terminal resource demand associated with said plurality of container carrier entries.

In an embodiment of the invention, said allocating terminal resources comprises automatically validating said allocated terminal resources, including said plurality of quay cranes, wherein the validating includes automatically establishing whether the allocated terminal resources of the container carrier entries comply with said terminal constraints and said preliminary terminal resource demand associated with said plurality of container carrier entries.

In an embodiment of the invention, said container carrier terminal system is configured to perform an optimization of said preliminary terminal resource plan based at least partially on said estimated container-related berth workloads.

In an embodiment of the invention, the container carrier terminal system is configured to carry out the method of the invention or any of its embodiments.

The invention further relates to a container carrier terminal comprising at least one quay crane and the container carrier terminal system of the invention or any of its embodiments.

In an embodiment of the invention, the container carrier terminal is configured to operate said at least one quay crane to perform transfer of containers associated with said container carrier during said crane time window.

The invention further relates to a computer program comprising instructions which, when the program is executed by a computer, cause the computer to carry out following steps:
storing in a container carrier terminal system a container carrier entry associated with a scheduled container carrier berth of a container carrier at a container carrier terminal comprising at least one quay crane; the container carrier being associated with static carrier information;
generating and preferably storing an estimated container-related berth workload associated with said container carrier berth based on said static carrier information;
performing and storing in said container carrier terminal system an allocation of said at least one quay crane to a crane time window which lies at least partially within an expected duration of said container carrier berth, wherein said allocation is performed prior to said container carrier berth and is based on said estimated container-related berth workload.

In an embodiment of the invention, the computer program further comprises instructions to cause the computer to carry out the following step: allocating said at least one quay crane to perform transfer of containers associated with said container carrier during said crane time window.

In an embodiment of the invention, the computer program further comprises instructions to cause the computer to carry out the following step: operating said at least one quay crane to perform transfer of containers associated with said container carrier during said crane time window.

In an embodiment of the invention, the computer program further comprises instructions to cause the computer to carry out the method of the invention or any of its embodiments.

### THE DRAWINGS

Various embodiments of the invention will in the following be described with reference to the drawings where

FIG. 1 illustrates a simplified view of an embodiment of the invention,

FIG. 2 illustrates a block diagram of a method according to an embodiment of the invention,

FIG. 3 illustrates allocation of a quay crane to a crane time window relative to an expected duration of a container carrier berth and rescheduling of a container carrier berth according to an embodiment of the invention,

FIG. 4 illustrates allocation of a plurality of quay cranes to a plurality of crane time windows relative to expected durations of these container carrier berths according to an embodiment of the invention,

FIG. 5 illustrates modifying the crane time window based on a declared container-related berth workload according to an embodiment of an invention,

FIG. 6 illustrate a workload predictor according to an embodiment of the invention,

FIG. 7 illustrates data processing equipment comprising different records of relevance to embodiments of the invention, and

FIG. 8 illustrates a container carrier terminal for handling container carriers of different sizes according to embodiments of the invention.

### DETAILED DESCRIPTION

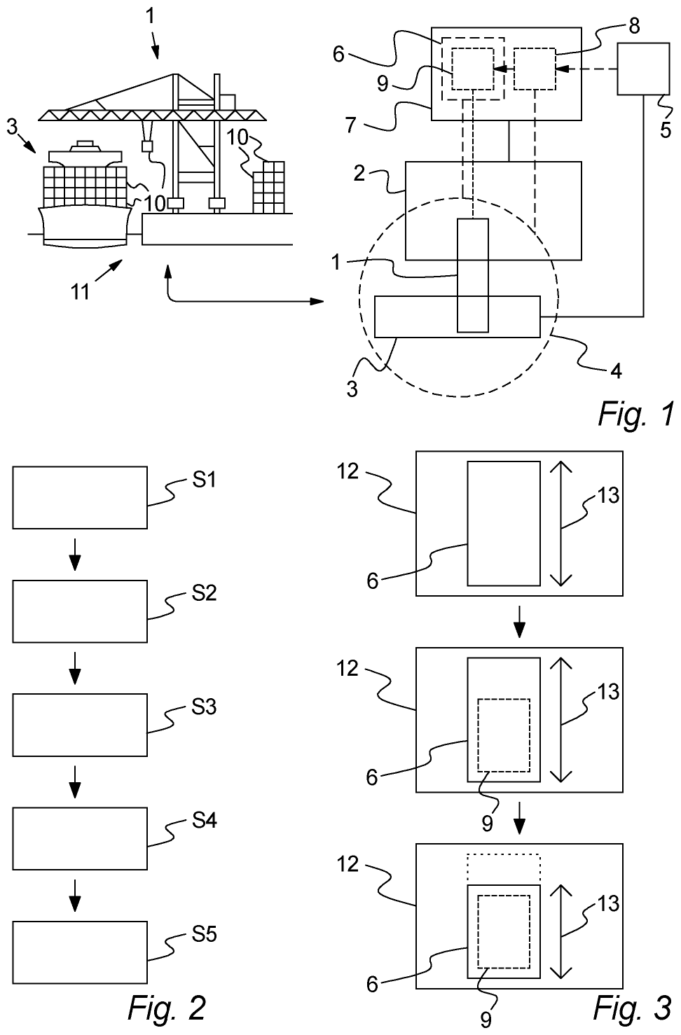

FIG. 1 illustrates a simplified view of an embodiment of the invention. The invention revolves around a container carrier berth 4, an event which involves a container carrier 3 visiting a container carrier terminal 2 which has at least one quay crane 1 to perform transfer of containers back and forth between the container carrier 3 and the container carrier terminal 2. In FIG. 1, a schematic view of the invention is shown to the right, whereas a more detailed view of the container carrier berth 4 is shown to the left.

Particularly, the invention relates to generating an estimated container-related berth workload prior to the container carrier berth 4, allocating at least one quay crane 1 to a crane time window 9 which lies at least partially within a duration of said container carrier berth 4, and preferably operating the allocated cranes accordingly. Even though FIG. 1 shows a container carrier berth taking place, note that the invention is related to method steps happening before that container carrier berth takes place.

The left side of FIG. 1 illustrates how a quay crane 1 may perform transfer of containers 10 between a container carrier 3 and a container terminal 2 or a quay 11 or a yard of a container terminal. This event wherein transfer of containers between container carrier 3 and container carrier terminal 2 takes place may be referred to as a container carrier berth.

The right side of FIG. 1 shows that the container carrier is associated with static carrier information 5, e.g. a container carrier route, or a container carrier identifier such as a name. A computer-implemented container carrier terminal system 7 associated with the container terminal 2 is supplied with a container carrier entry 6 which is a digital representation of the container carrier berth. The container carrier entry may thus be linked to the static carrier information (not directly shown in FIG. 1), be associated with tentative arrival and departure times of the container carrier at the container carrier terminal and be linked to a container-related berth workload, e.g. the estimated container-related berth workload.

According to the embodiment, an estimated container-related berth workload 8 is generated based on the static carrier information 5. Then, the quay crane 1 is allocated to a time window which lies at least partially within a duration of the container carrier berth. For example, if the container carrier entry is associated with a tentative arrival time of which lies two weeks ahead at 13:00, and a tentative departure time which lies two weeks ahead at 21:00, the quay crane is allocated to a crane time window which lies at least partially within the duration from two weeks ahead at 13:00 to two weeks ahead at 21:00, for example a crane time window which lies from two weeks ahead at 14:00 to two weeks ahead at 20:00. Then, following this example, when the container carrier 3 arrives two weeks after allocating the quay crane 1 to the crane time window 9, the quay crane is operated to perform transfer of containers between the container carrier 3 and the container carrier terminal 2 during this crane time window 9.

FIG. 2 illustrates a block diagram of a method according to an embodiment of the invention. In this embodiment, the method comprises five steps S1-S5.

In a first step S1, a container carrier is scheduled to perform a container carrier berth at a container carrier terminal. The container carrier is associated with static carrier information.

This scheduling may for example be an establishment of a contractual agreement between a manager of the container carrier and a manager of the container carrier terminal. The manager of the container carrier may for example be a shipping company. An example of a contractual agreement is a pro-forma plan. In a pro-forma plan, a shipping company agrees to arrive at one or more container carrier terminals on a regular basis, e.g. on a weekly basis. Multiple container carriers of that shipping company are then assigned to a container carrier route, to fulfil this proforma plan, e.g. to arrive at a container terminal on a weekly basis. The pro-forma plan may typically also include a contractual cargo capacity, e.g. the number of containers which are required to be transferred during a container carrier berth of the pro-forma plan. However, this number may be substantially inaccurate.

Establishing a pro-forma plan is an example of a step scheduling a container carrier to perform a container carrier berth according to the invention. However, note that the invention is not limited to scheduling through a contractual agreement or a pro-forma plan. Scheduling a container carrier to perform a container carrier berth may for example be scheduling a single container carrier berth, e.g. not related to a specific container carrier route.

The next step S2 is to supply a container carrier entry, e.g. a digital representation of the scheduled container carrier berth, to a container carrier terminal system of the container carrier terminal.

The container carrier entry may typically be associated with information relating to the container carrier and/or the container carrier route related to the container carrier berth. The container carrier entry may typically also comprise a tentative arrival time and a tentative departure time. Further, the container carrier entry may comprise a contractual container-related berth workload, e.g. an initially agreed-upon number of containers to be loaded and/or unloaded during the scheduled container carrier berth.

The next step S3 is to generate an estimated container-related berth workload associated with the container carrier berth and based on the static carrier information.

In some embodiments, the estimated container-related berth workload is generated by an automatically applied number of mathematical operations to a contractual estimated container-related berth workload, e.g. multiplying by a factor of 0.75.

In some embodiments, the estimated container-related berth workload is generated based on a historical berth database. For example, past container carrier berths of the same container carrier route are found in the historical berth database, and the estimated container-related berth workload is calculated as an average or as a weighted average of the actual container-related berth workload of these past container carrier berths.

In some embodiments, the estimated container-related berth workload is generated based on the number of containers temporarily stored in the container carrier terminal.

In some embodiments, the estimated container-related berth workload is generated by a workload predictor, e.g. a workload predictor associated with a workload prediction algorithm. For example, a workload prediction algorithm based on a historical berth database.

The next step S4 is to allocate at least one quay crane to a crane time window which lies at least partially within an expected duration of the container carrier berth. The allocation is based on the estimated container-related berth workload. E.g. more containers to be loaded and/or unloaded requires longer allocated crane time window. For example, if a quay crane is able to unload 20 containers per hour and a container carrier requires 100 containers to be unloaded, the quay crane is allocated in a crane time window which lasts 5 hours. If instead to container carrier requires 200 containers to be unleaded, the quay crane is allocated in a crane time window of 10 hours.

The crane time window lies at least partially within an expected duration of said container carrier berth. The crane time window may for example lie fully within, or it may lie partially within. Crane time windows which lie partially, and not fully, within the expected duration of the container carrier berth may for example be further based on a constraint of the quay crane. The quay crane may for example also be allocated to perform transfer of containers in relation to an auxiliary container carrier berth. In such cases, the arrival and/or departure time of the container carrier may for example be rescheduled, such that the crane time window lies within an updated expected duration based on the rescheduling.

In some embodiments, the duration of the crane time window and/or the location of the crane time window may take other factors into account such as crane movement, breaks of gangs of workers operating the quay crane etc.

The allocation of the quay crane to a quay time window takes place prior to the actual container carrier berth, such that this allocation may be used as an element in planning long-term operations of the entire container carrier terminal.

The next step S5 is to operate the at least one quay crane to perform transfer of containers associated with said container carrier during the crane time window. In typical embodiments, the time duration of the operation may typically be approximately equal to the crane time window. However, operations can proceed faster or slower than expected. Therefore, the quay crane is not restricted to be operated within the full duration of the crane time window.

In some embodiments, the operation of the at least one quay crane in relation to the container carrier berth is primarily performed during said crane time window.

In some embodiments, the operation of the at least one quay crane in relation to the container carrier berth is only performed within the crane time window.

In some embodiments, the at least one quay crane is operated within the full duration of the crane time window.

In some embodiments of the invention, the step of generating S3 and/or the step of allocating S4 are/is repeated several times in the duration extending from the step of step of supplying S2 to the step of eventually operating S5. For example, each time new information relating to the scheduled container carrier berth is received, a new estimated container-related berth workload is be generated. And based on this, at least the quay crane is allocated to a time window anew. Or, for example, an auxiliary container carrier berth of an auxiliary container carrier may be rescheduled to influence the container carrier berth which the at least one quay crane is allocated with respect to, and based on this, the at least one quay crane is allocated once again.

It should be noted that the rescheduling may be performed according the provisions of the invention by means of new allocation of a crane or in crane in another time window may be eventually executed operationally, but it should also be noted that intermediate updating of allocations of crane resources are highly advantageous even if, at the end, a final execution plan is made on the basis of a work-load which is now known and not estimated. The use of historical data for making an estimation of the workload, e.g. in terms of container moves, has proven attractive in relation to the transition between using estimated workload data and known workload data for allocation of crane(s).

FIG. 3 illustrates allocation of a quay crane to a crane time window relative to an expected duration of a container carrier berth and rescheduling of a container carrier berth according to an embodiment of the invention.

In the figure, three panels are shown (top, middle, bottom), which illustrate how a process of rescheduling according to the invention may take place. Each of the panels is a graphical representation of a resource allocation environment 12. In the shown graphical representation 12, the vertical axis indicate time and the vertical extend of a container carrier entry 6 is indicative of the expected duration of the container carrier berth 13. The vertical location of the container carrier entry is indicative of the tentative arrival time and the tentative departure time. Similarly, the vertical extend and of a crane time window 9 indicate the timing and duration of the crane time window 9, for example relative to the container carrier entry 6.

Such a graphical representation 12 may comprise a plurality of container carrier entries and a plurality of quay crane windows of one or more allocated quay cranes.

In this embodiment, the graphical representation 12 is executed from top to bottom, i.e. the arrow of time and the time axis points downwards. However, embodiments of the invention are not restricted to any particular arrangement of axes.

In the top panel, a container carrier entry 6 is shown in the graphical representation 12. It has an expected duration 13, but no associated crane time window.

In the middle panel, a quay crane has been allocated to a crane time window 9 within the expected duration of the container carrier berth and based on an estimated container-related berth workload. The estimated container-related berth workload is low compared to the expected duration of the container carrier berth 13, and accordingly, the crane time window 9 is substantially shorter than the expected duration of the container carrier berth 13.

Given the crane time window 9, it is possible for the container carrier to arrive later without compromising the number of container which need to be loaded and/or unloaded. Based on the allocation, the container carrier terminal, or a manager hereof, contacts the container carrier, or a manager hereof. The container carrier or the manager of the container carrier is informed that it is possible to slow the container carrier down to reduce emission of greenhouse gases by the container carrier, and a new tentative arrival time is agreed upon.

The bottom panel shows how the container carrier entry 6 may be updated based on the crane time window 9, thus reducing the expected duration of the container carrier berth 13 allowing the container carrier to reduce its cruising speed to reduce emission of greenhouse gases.

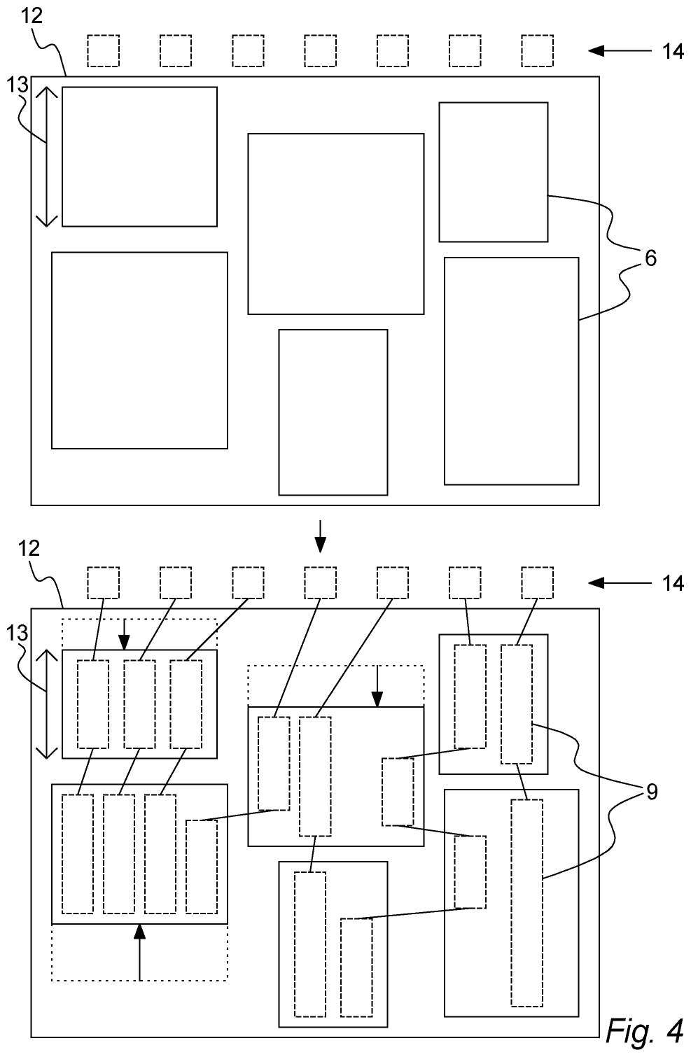

FIG. 4 illustrates allocation of a plurality of quay cranes to a plurality of crane time windows relative to expected durations of these container carrier berths according to an embodiment of the invention.

This figure shows two panels (top, bottom) which illustrate allocating a plurality of quay cranes to container carrier entries with inter-dependencies and constraints. Each of the panels is a graphical representation of a resource allocation environment 12. As in FIG. 3, the vertical axis indicate time. Further, the horizontal axis indicates a position along the quay of the container carrier terminal. Thus, the horizontal location and extend of a container carrier entry indicate expected position and extend of the container carrier association with the container carrier entry. The horizontal extend of the container carrier entry may thus also indicate how many quay cranes which may perform simultaneous transfer of containers on the container carrier associated with the container carrier entry.

Each of the two panels are associated with a number of quay crane representations. In this exemplary illustration, seven quay crane representations are shown, indicating that seven quay cranes are available for allocation.

The top panel shows six container carrier entries 6 distributed at different times and quay positions within the graphical representation 12. Here, no of the quay cranes have been allocated to any of the container carrier entries.

The bottom panel shows an exemplary allocation of the seven quay cranes to various crane time windows within the expected durations of the six container carrier entries. The allocation is based on an estimated container-related berth workload of each container carrier entry. In the graphical representation 12, the allocation of a quay crane to one or more quay crane time windows 9 is indicated by lines extending from the quay crane representations 14 to related crane time windows 9, and between crane time windows 9 of the same quay crane.

In the allocation, each container carrier entry has one or more quay cranes allocated to one or more crane time windows 9. The crane time windows 9 of each container carrier entry 6 does not necessarily have the same extend. But preferably, the summarized extend of the crane time windows of a given container carrier entry should, at least to some extent, be based on the estimated container-related berth workload of the associated container carrier berth. Note that the maximum number of quay cranes associated with a container carrier/container carrier entry is not necessarily allocated to a container carrier entry. For example, a container carrier may be arranged to have four quay cranes to simultaneously perform transfer of containers, but only three are allocated.

In this embodiment, the allocation is performed based on crane allocation constraints. For example, quay cranes are not allocated such that they are required to cross each other along the quay during operation. Further, each quay crane is not allocated to more than one crane time window at a time. Additionally, the allocation has been performed with respect to a built-in movement time of cranes between different positions along the quay. However, note that embodiments of the invention are not restricted to particular crane allocation constraints.

In some embodiments, the allocation is performed manually. In some embodiments, the allocation is performed automatically. The allocation may further be based on an optimization, for example an optimization to maximize the potential reduction of greenhouse gases by minimizing the potential expected durations 13 of the container carrier entries 6.

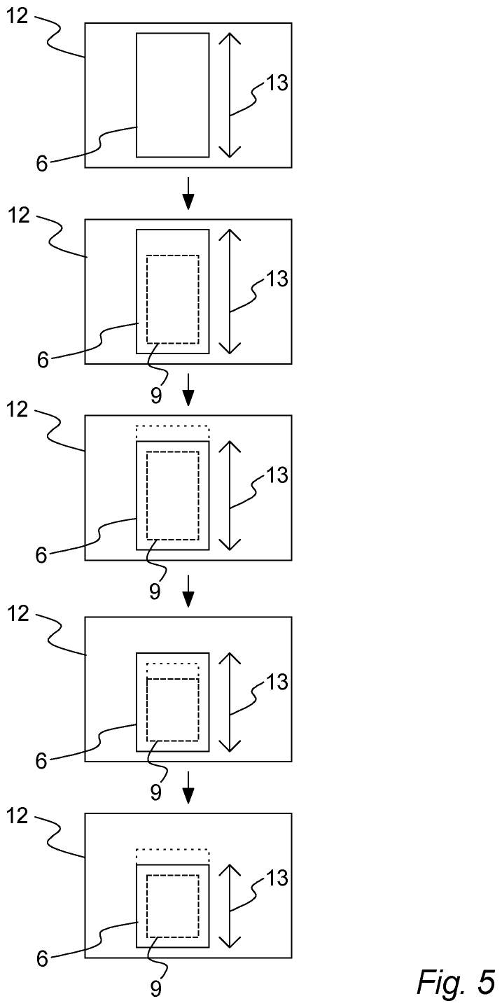

FIG. 5 illustrates modifying the crane time window based on a declared container-related berth workload according to an embodiment of an invention.

In the figure, five panels are shown (top to bottom: first, second, third, fourth, and fifth panel), which illustrate how a process of rescheduling according to an embodiment of the invention may take place. Each of the panels is a graphical representation of a resource allocation environment 12, as also illustrated in FIG. 3. In the shown graphical representation 12 of FIG. 5, the vertical axis once again indicates time and the vertical extend of a container carrier entry 6 is indicative of the expected duration of the container carrier berth 13. The vertical location of the container carrier entry is thus indicative of the tentative arrival time and the tentative departure time. Similarly, the vertical extend and of a crane time window 9 indicate the timing and duration of the crane time window 9, for example relative to the container carrier entry 6.

In this embodiment, the graphical representation 12 is executed from top to bottom, i.e. the arrow of time and the time axis points downwards.

In the first panel, a container carrier entry 6 is shown in the graphical representation 12. It has an expected duration 13, but no associated crane time window.

In the second panel, a quay crane has been allocated to a crane time window 9 within the expected duration of the container carrier berth and based on an estimated container-related berth workload. The estimated container-related berth workload is low compared to the expected duration of the container carrier berth 13, and accordingly, the crane time window 9 is substantially shorter than the expected duration of the container carrier berth 13.

Given the crane time window 9, it is possible for the container carrier to arrive later without compromising the number of container which need to be loaded and/or unloaded. Based on the allocation, the container carrier terminal, or a manager hereof, contacts the container carrier, or a manager hereof. The container carrier or the manager of the container carrier is informed that it is possible to slow the container carrier down to reduce emission of greenhouse gases by the container carrier, and a new tentative arrival time is agreed upon.

The third panel shows how the container carrier entry 6 may be updated based on the crane time window 9, thus reducing the expected duration of the container carrier berth 13 allowing the container carrier to reduce its cruising speed to reduce emission of greenhouse gases.

At a later point in the voyage of the container carrier, a manager of the container carrier provides a declared container-related berth workload to the container carrier terminal. For example, the container carrier has performed a container carrier berth in an auxiliary container carrier terminal after the estimated container-related berth workload was generated, and now the manager of the container carrier has a better overview of how many containers are required to be transferred during the container carrier berth at the container terminal.

As a consequence of receiving the declared container-related berth workload, the estimated container-related berth workload is generated again, now taking this new information into account. Resultingly, a smaller estimated container-related berth workload is generated, and accordingly, the at least one quay crane is allocated to a shorter crane time window.

The fourth panel shows the implementation of a shorter crane time window 9 in the container carrier entry 6.

Given this updated crane time window 9, it is possible for the container carrier to arrive even later without compromising the number of container which need to be loaded and/or unloaded. Based on this new allocation, the container carrier terminal, or a manager hereof, contacts the container carrier, or a manager hereof, again. The container carrier or the manager of the container carrier is informed that it is possible to slow the container carrier further down to further reduce emission of greenhouse gases by the container carrier, and a new tentative arrival time is agreed upon.

The fifth panel shows how the container carrier entry 6 may be updated again based on the new crane time window 9, thus reducing the expected duration of the container carrier berth 13 further, allowing the container carrier to reduce its cruising speed further to reduce emission of greenhouse gases even more.

Note that even though the declared container-related berth workload is closer to the actual container-related berth workload than the estimate container-related berth workload, generating an estimated container-related workload is still advantageous, since it allows a preliminary allocation which is close a final allocation, upon which operation of at least one quay crane is based on. The invention thus allows a larger degree of detailed long-term planning, which in may ensure certainty of delivery of goods, enables faster delivery of goods, and reduce emission of greenhouse gases.

Also, note that even though the container carrier or a manager of the container carrier may have detailed knowledge relating to how many containers requires to be unloaded to the container carrier terminal during the container carrier berth, the container carrier terminal may e.g. have detailed knowledge relating how many containers requires to be loaded to the container carrier during the container carrier berth. Thus, even though the declared container-related berth workload may be the exact number of containers which need to be unloaded, the crane allocation may further require taking the number of containers which need to be loaded into account. Consequently, even a precise and accurate declared container-related berth workload provided well ahead of the container carrier berth may not be sufficient, in itself, to properly allocate one or more quay cranes to time windows which are precise and accurate to handle the actual container-related berth workload.

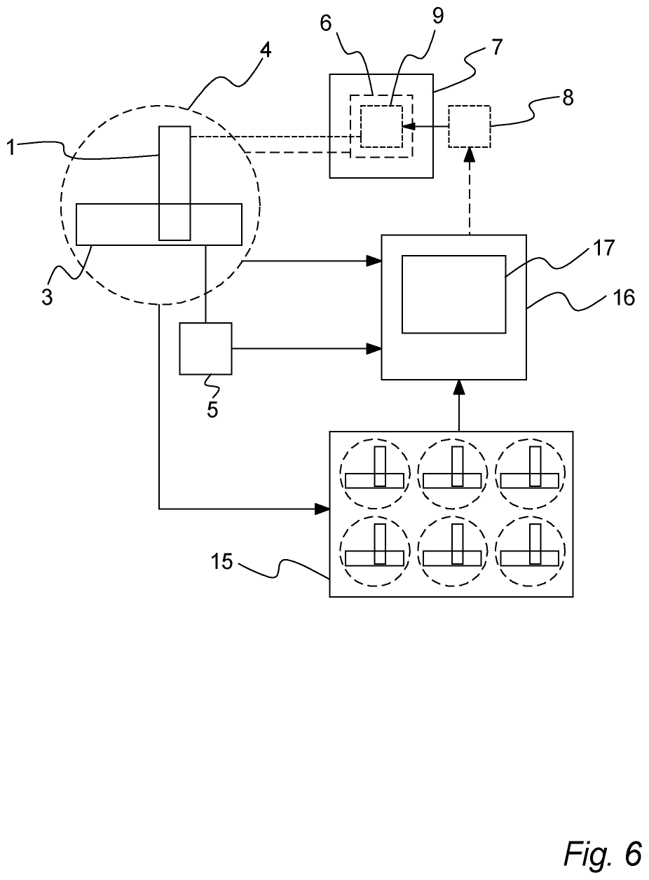

FIG. 6 illustrate a workload predictor 16 according to an embodiment of the invention. The workload predictor is linked to a historical berth database 15, and further, the workload predictor is a computer system comprising a workload prediction algorithm 17.

In this embodiment, the workload prediction algorithm 17 is based on machine learning, and the historical berth database 15 is used as a training dataset for the machine learning. That is, the workload prediction algorithm 17 has been trained to predict/estimate a container-related berth workload based on the historical berth database 15.

The historical berth database 15 comprises records of past container carrier berths. For example, past container carrier berths at the container carrier terminal. For example, the actual container-related berth workloads of these container carrier berths, and static carrier information relating to these container carrier berths.

Upon scheduling of a container carrier berth 4 of a container carrier 1 at the container carrier terminal (not shown), a container carrier entry 6 associated with the container carrier berth is supplied to a container carrier terminal system 7. The container carrier is associated with static carrier information which is provided to the workload predictor 16. The workload predictor 16 further receives information relating to the container carrier berth, e.g. container carrier terminal, time and date, etc. Based on the received data and the machine learning trained using the historical berth database, the workload predictor 16 and its workload prediction algorithm 17 generated an estimated container-related berth workload 8.

Based on the estimated container-related berth workload 8, at least one quay crane 1 is allocated to a crane time window 9 which lies within an expected duration of the container carrier berth 4. The allocation is performed prior to the actual container carrier berth 4.

Upon arrival of the container carrier at the container carrier terminal and the at least one quay crane 1, the at least one quay crane 1 is operated within the crane time window 9.

After the container carrier berth, an actual container-related berth workload is supplied to the historical berth database 15, for example together with further information relating to the container carrier berth and static carrier information.

In some other embodiments of the invention, workload predictor 16 is not based on a historical database 15.

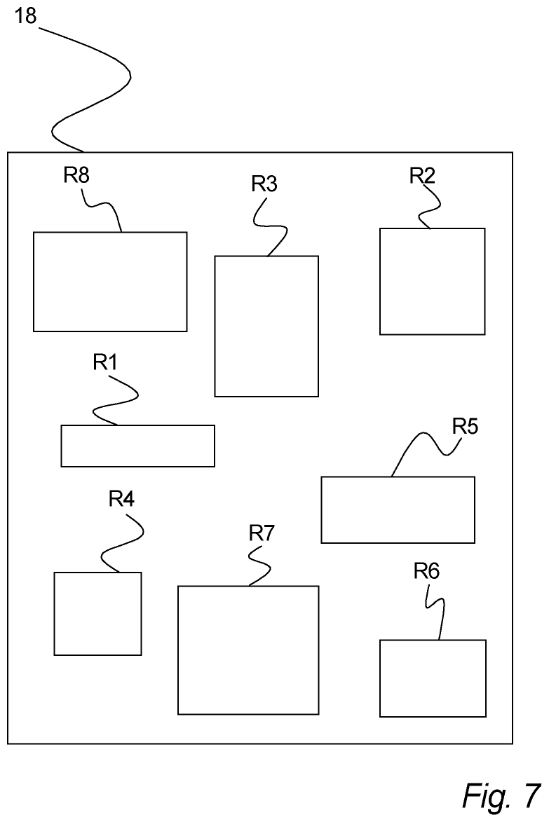

FIG. 7 illustrates data processing equipment 18 comprising different data records of relevance to embodiments of the invention. Data processing equipment DPE may for example be one or more computers/servers, for example based on cloud storage.

The data processing equipment 18 comprises at least one or more crane time window data records R1, one or more container carrier entry data records R2, one or more container carrier data records R3, one or more gang data records R4, one or more maintenance data records R5, one or more container carrier terminal data records R6, one or more gang allocation data records R7, and one or more quay crane data records R8.

A quay crane data record R8 may be understood as a digital record of a quay crane. In this exemplary embodiment, this record comprises the information shown here:

| Field | Value |
|---|---|
| ID | 1 |
| Name | QC01 |
| Height | 53 meters |
| Outreach | 70 meters |
| Range from | 100 meters |
| Range to | 800 meters |

A container carrier data record R3 may be understood as a digital record of a container carrier. In this exemplary embodiment, this record comprises the information shown here:

| Field | Value | |
|---|---|---|
| ID | 123 | |
| IMO | 9778791 | |
| Name | Madrid Maersk | |
| Length | 399 | meters |
| Beam | 58.6 | meters |
| Total cargo capacity | 20,568 | TEU |

A container carrier entry data record R2 may be understood as a digital record of a container carrier entry. In this exemplary embodiment, this record comprises the information shown here:

| Field | Value |
|---|---|
| ID | 123 |
| Vessel_ID | 123 |
| Service | Asia Europe (AE10) |
| Moves Load | 200 |
| Moves reload | 400 |
| Moves redistribute | 50 |
| GMPH | 30 |
| Target vessel rate | 80 |
| Pilot station arrival | 2/4/2020 11:00 |
| Berth arrival | 2/4/2020 12:00 |
| Cargo start | 2/4/2020 12:00 |
| Cargo end | 2/4/2020 18:00 |
| Berth departure | 2/4/2020 18:10 |
| Maximum cranes | 6 |
| Quay start | 400 |
| Quay end | 799 |

Here, the berth arrival or the cargo start may for example be the tentative arrival time, and the berth departure or the cargo end may be the tentative departure time.

A crane time window data record R1 may be understood as a digital record of a crane allocation/quay crane allocation. In this exemplary embodiment, this record comprises the information shown here:

| Field | Value |
|---|---|
| Crane_ID | 1 |
| Port call: | 123 |
| Start | 2/4/2020 12:00 |
| End | 2/4/2020 18:00 |

Here, the port call may be understood as the container carrier entry.

A maintenance data record R5 may be understood as a digital record of a maintenance, e.g. a maintenance of a quay crane or a part of a quay. In this exemplary embodiment, this record comprises the information shown here:

| Field | Value |
|---|---|
| Crane_ID | 1 |
| Maintenance type | Corrective maintenance |
| Start | 1/2/2020 11:00 |
| End | 1/2/2020 23:00 |

A gang data record R4 may be understood as a digital record of a gang of workers, e.g. a gang of workers suitable for operating a quay crane. In this exemplary embodiment, this record comprises the information shown here:

| Field | Value |
|---|---|
| Gang_ID | 2 |
| Number of workers | 10 |
| Regular shift start | 8:00 |
| Regular shift end | 16:00 |

A gang allocation data record R7 may be understood as a digital record of an allocation of a gang, e.g. to a quay crane. In this exemplary embodiment, this record comprises the information shown here:

| Field | Value |
|---|---|
| Gang_ID | 2 |
| Crane_ID | 1 |
| Port call | 123 |
| Allocation start | 2/4/2020 12:00 |
| Allocation end | 2/4/2020 16:00 |

A container carrier terminal data record R6 may be understood as a digital record of a container carrier terminal. In this exemplary embodiment, this record comprises the information shown here:

| Field | Value |
|---|---|
| terminal_ID | 321 |
| Number of gangs 8:00-16:00 | 10 |
| Number of gangs 16:00-24:00 | 8 |
| Number of gangs 00:00-08:00 | 6 |
| Number of cranes | 8 |
| Quay length | 1000 meters |
| Allocation end | 2/4/2020 16:00 |

The above examples of records should be seen as exemplary. Any records according to embodiments of the invention may comprise any information and be linked in any manner within the scope of the invention as defined by the claims.

In particular, it should be mentioned that quay crane records and/or their associated maintenance within the scope of the present invention may be represented in numerous different ways as long as the allocation of a terminal resource in the form of a quay crane may be allocated in the system for use in connection with container carriers and their respective associated container carrier entries. It should also be noted that the maintenance and preferably also restrictions/constraints resulting from a planned maintenance related to e.g. cranes and/or berth should be contained and be processable to a degree that makes it possible to automatically calculate/validate whether the a planned maintenance of one terminal resource affect the functioning/applicability of further non-maintained resources.

Such constrictions may be applied or contained in separate records but they may e.g. also be contained in relevant resource records. An example of such may be a crane record including e.g. location at where the crane is or is to be maintained and also an information of whether the crane can be moved. This has the effect that a crane which is down for breakdown maintenance may be identified as non-movable and therefore blocking for movement of neighboring cranes and therefore making these neighboring cranes non-usable or restricted during maintenance. Other such “cross” terminal resource constraints may be applied or included for automatic calculation/validation of applicability of terminal resources, i.e. whether these are available or to what degree they are available.

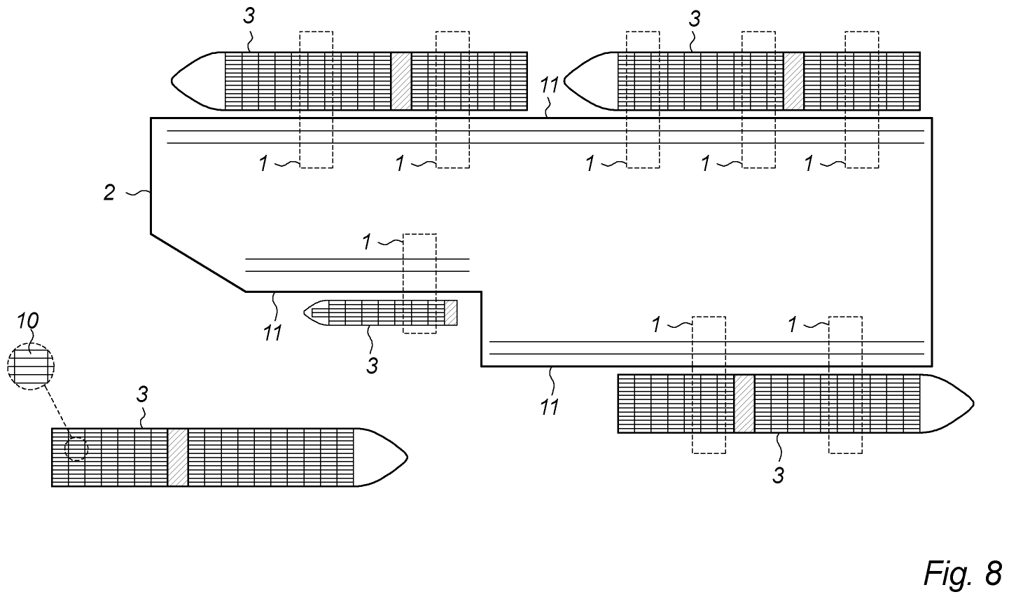

FIG. 8 illustrates a container carrier terminal 2 for handling container carriers 3 of different sizes according to embodiments of the invention. The container carrier terminal 2 comprises three quays 11 at which container carriers 3 may berth, as well as a plurality of quay cranes 1 disposed at the quays 11. As shown in FIG. 8, four container carriers 3 are currently berthing at the container carrier terminal 2 at the quays 11 of the container carrier terminal 2 and being serviced by the quay cranes 1.

From the above, it is now clear that the invention relates to method and a system for planning and/or operating a quay crane based on a crane time window, which in turn is based on an estimated container-related berth workload. Long-term planning in container carrier terminals is extremely challenging and due to the high degree of complexity and many unknown factors. By cleverly estimating the number of containers which need to be loaded and unloaded during a future container carrier berth, it thus possible to improve long-term planning of container terminals, which ensures delivery of goods to consumers and production facilities, and which allows container carriers to reduce their speed between container terminals to reduce emission of greenhouse gases.

The invention has been exemplified above with the purpose of illustration rather than limitation with reference to specific examples of methods and systems for improved quay crane operation. Details such as a specific method and system structures have been provided in order to understand embodiments of the invention. Note that detailed descriptions of well-known systems, devices, circuits, and methods have been omitted so as to not obscure the description of the invention with unnecessary details. It should be understood that the invention is not limited to the particular examples described above and a person skilled in the art can also implement the invention in other embodiments without these specific details. As such, the invention may be designed and altered in a multitude of varieties within the scope of the invention as specified in the claims.

In the present context all validation may be performed automatically unless specifically otherwise noted.

At least two principally different ways of initiating a validation may be applied within the scope of the invention. A fully automatic initiation which simply validates when instructed by the planning program logic. Such autonomous validation may not necessary be overruled by a semi-automatic validation which is automatically initiated when a user of a user interface provides inputs e.g. modification(s) of container carrier entries, additions or removals of container carrier entries, modifications of existing available terminal resources, additions or removals terminal resources, modifications of constraints such as maintenance etc.

A validation in the present context can for example involve an analysis of whether one, all, or a group of container carrier entries are “matched” with allocated terminal resources. In other words, are the demands related to the container carrier entries fulfilled by the terminal resources allocated to the container carrier entries already input and made active in a preliminary or updated terminal resource plan. It may also refer to a non-validated terminal resource plan of ghost entries which is in its making e.g. on the basis of a modification of an active updated terminal resource plan. Such validation may thus be made on ghost data of one scenario based on a modification of an existing terminal resource plan, preliminary or updated terminal resource plan, but it may also be performed on several alternative scenarios of which a berth planner may choose to make one of these active as an updated terminal resource plan.

A validation may be performed if something has changed in the existing active distribution of container carrier entries vs respective allocated terminal resources and upon registration by manual input of this change by a user of the user interface or by an automatic registration of the change, an automatic validation is performed across all configured container carrier entries vs respective allocated terminal resources. Such a validation may in the present context not only just validate whether the allocation is OK, but it can optionally also result in a warning displayed or otherwise communicated to a user of the container carrier terminal system planning system (which may also be referred to and understood as a berth plan configurator), if the it turns out the present demands as expressed by the container carrier entries (and optional associated logic) are not met validly by the presently allocated terminal resources.

Factors relevant for such demands may e.g. refer to time, ETA and ETD, number of containers to be unloaded, which resources are available for the unloading, berth locations, cranes, crane gangs etc.

A validation may also be performed for the purpose of checking whether an auxiliary resource scenario is valid before implementing that scenario as the master resource scenario in an updated terminal resource plan. In other words, such a situation may occur upon a determination the existing berth plan/resource plan is not valid anymore (e.g. due to updated constraints or demands) and now the berth planner and/or an automatic routine are trying to figure out which adjustments to implement to ensure that allocated resources comply with demands once again. This may not always be an easy task and in an advantageous embodiment of the invention, changes of an existing and active berth plan are not made before the considered changes are validated by the system, e.g. as one or more alternatives which may be checked/validated before being made active as an updated terminal resource plan.

In other words, the container carrier terminal system enables that a user may validate a plan before making it active as well as validate the resource plan automatically if changes has occurred in relation to container carrier entries, allocated terminal resource, demands, or constraints such as maintenance.

It should be noted that the above changes may of course relate to if a container carrier entry is added or deleted, and if terminal resources are added or deleted, but the changes may preferably also include changes in demands, such as ETA and ETD, number of containers to be unloaded, and also whether the allocated resources has a modified performance, e.g. a part of the berth is not available, a crane is now non-available in relation to maintenance, a crane is now more or less efficient due to maintenance or availability of a more or less efficient gang, a crane is not applicable for certain berth positions due to another crane down for maintenance which is blocking the track, etc.

In other words, changes which preferably trigger automatic validation includes modified demand and modified resources.

A validation in the present context should preferably also result in a communication, e.g. by displaying, one or more factual conflicts/violations if such are available and the validation should preferably also result in the that such conflicts are categorized such that a manual operator of the configurator, i.e. the container carrier terminal system, is able to perceive the detected conflicts and make a modification of the berth plan on the basis of these. Such categorization of conflicts may include determination that specific cranes are now “double booked” or that specific cranes are already booked (if trying to validate a new container carrier entry) and the quantization could also include when the specific crane(s) are available or not.

This categorization may advantageously also be present and provided to a user upon a positive validation, i.e. if it turns out that the berth planner has succeeded in finding a new way of implementing allocations which comply with the demands. This may in particular be of user for a berth planner when the berth planner seeks to find more and alternative configurations to meet the same demand. This may e.g. be performed by working out separate resource scenarios and automatically having these validated. It may of course be very difficult to find a valid new configuration, e.g. if a demand it updated (e.g. a new ETA) or if a crane is requiring planned or acute maintenance, but it is even more difficult to find and optimize a new configuration where the allocated resources match the demand.

In an advantageous embodiment of the invention, the configurator, i.e. the container carrier terminal system, allows the planner to work with multiple alternative scenarios prior to making one of these active but the validation not only provides quantized (detailed) warning if a scenario is not valid, but also provides details if the scenario is valid. Such details could e.g. be an overall automatic calculation of the added cost in relation to gangs/workforce of a certain configuration is used. Several other parameters may also be outputted for the assisting of the berth planner to determine which valid scenario to choose and activate.

In a further embodiment of the invention, such classifications may be both shown (made available, e.g. be automatically displayed) to the berth planner. The respective quantization of the different scenarios may also be logged for the training of artificial intelligence to determine typical priorities made when a berth planner chooses one scenario over another. This may be used for an automatic computer-made choosing of one scenario over another/other scenario(s) or at least an automatic prioritizing of these scenarios which may be communicated to the berth planner for the assisting of the berth planner in choosing the optimal valid scenario among a number of valid scenarios.

In a computer implemented validation according to an embodiment of the invention, an auxiliary resource scenario is to be validated before being considered for activation and use as a master resource scenario/updated terminal resource plan. The auxiliary resource scenario may e.g. be established to figure out how to handle a planned maintenance or a breakdown (urgent) maintenance in an optimal way.

The auxiliary scenario is initially validated by a validation process by data processing equipment 18 (as shown in FIG. 7) in a validation process step.

If outcome of the validation is that the auxiliary scenario is OK, the auxiliary scenario is then classified in a classification step. The classification involves that a number of different aspects, e.g. cost related to the specific maintenance used in the validated auxiliary scenario. Further costs may also be included in relation to the classification of the validated scenario, which may e.g. include classification of induced and required delays of container carrier entries involved in the establishment a new and valid berth plan, cost related to use of gangs in the scenario, priority given to certain container carrier operators etc.

Such classifications may then be stored and logged in a database and also displayed to a user in graphical user interface.

If, on the other hand the auxiliary scenario is turning out to be non-OK in the validation step, the in-validity of the scenario is categorized so as to allow the berth planner to find out where the conflicts are and preferably also the extent of determined the conflict(s).

The result is then displayed in a display step and the result may also be stored and logged in a database.

The above validation may be repeated for each auxiliary scenario and for each time an auxiliary scenario is updated with respect to demands and/or terminal resources.

### LIST OF REFERENCE SIGNS

1 Quay crane
2 Container carrier terminal
3 Container carrier
4 Container carrier berth
5 Static carrier information
6 Container carrier entry
7 Container carrier terminal system
8 Estimated container-related berth workload
9 Crane time window
10 Container
11 Quay
12 Graphical representation of resource allocation environment
13 Expected duration of container carrier berth
14 Quay crane representations
15 Historical berth database
16 Workload predictor
17 Workload prediction algorithm
18 Data processing equipment
R1-R8 Data records
S1-S5 Method steps

1-81. (canceled)

82. A method for operating and/or allocating at least one quay crane at a container carrier terminal, said method comprising:
scheduling a container carrier to perform a container carrier berth at said container carrier terminal, wherein said container carrier is associated with static carrier information;
supplying a container carrier entry associated with said container carrier berth to a computer-implemented container carrier terminal system associated with said container carrier terminal;
generating an estimated container-related berth workload associated with said container carrier berth based on said static carrier information; and
allocating said at least one quay crane to a crane time window which lies at least partially within an expected duration of said container carrier berth, wherein said allocating said at least one quay crane is performed in said container carrier terminal system prior to said container carrier berth and is based on said estimated container-related berth workload.

83. The method according to claim 82, wherein the method further comprises operating said at least one quay crane to perform transfer of containers associated with said container carrier during said crane time window.

84. The method according to claim 82, wherein said step of generating an estimated container-related berth workload is performed automatically.

85. The method according to claim 82, wherein said step of allocating said at least one quay crane based on said estimated container-related workload is performed automatically.

86. The method according to claim 82, wherein said step of allocating said at least one quay crane further comprises allocating a quay crane of said at least one quay crane to a quay crane position.

87. The method according to claim 83, wherein said step of operating said at least one quay crane comprises moving a quay crane of said at least one quay crane from a respective first quay crane position to a respective second quay crane position.

88. The method according to claim 82, wherein said allocating said at least one quay crane is based on crane allocation constraints.

89. The method according to claim 82, wherein said allocating said at least one quay crane comprises allocating a plurality of quay cranes to a plurality of crane time windows such that each quay crane of said plurality of quay cranes is allocated to a respective crane time window of said plurality of crane time windows; and
wherein said operating said at least one quay crane comprises operating each quay crane of said plurality of quay cranes to perform transfer of containers associated with said container carrier during said respective crane time window of said plurality of crane time windows.

90. The method according to claim 82, wherein said estimated container-related berth workload is indicative of one or more of the following: a cargo capacity to be unloaded from said container carrier to said container carrier terminal during said container carrier berth, a cargo capacity to be loaded from said container carrier terminal to said container carrier during said container carrier berth, and a cargo capacity to be redistributed on said container carrier during said container carrier during said container carrier berth.

91. The method according to claim 82, wherein said estimated container-related berth workload is indicative of a number of quay crane workhours required during said container carrier berth.

92. The method according to claim 82, wherein said container carrier entry is associated with a tentative arrival time of said container carrier and a tentative departure time of said container carrier.

93. The method according to claim 82, wherein said method comprises a step of receiving a declared container-related berth workload from said container carrier after allocating said at least one quay crane, and wherein said method comprises a step of modifying said crane time window based on said declared container-related berth workload.

94. The method according to claim 82, wherein said generating said estimated container-related berth workload is based on a workload predictor associated with a workload prediction algorithm, and wherein said workload predictor is executed by data processing equipment.

95. The method according to claim 82, wherein said static carrier information represent one or more of the following: a container carrier identifier, a container carrier type, a container carrier manager, a container carrier size, and a container carrier volume.

96. The method according to claim 82, wherein said generating said estimated container-related berth workload is based on a historical berth database, and wherein said historical berth database comprises one or more past container carrier berth representations or aggregation thereof.

97. The method according claim 94, wherein said workload prediction algorithm is based on machine learning, and wherein a historical berth database is a training dataset used for said machine learning.

98. The method according to claim 82, wherein said method further comprises:
providing, in said container carrier terminal system, a model of said container carrier terminal executed on data processing equipment, said model comprising representations of terminal resources and terminal constraints relating to said terminal resources, wherein said terminal resources comprise said at least one quay crane and said representations of terminal resources including representations of said at last one quay crane; and
inputting, in said container carrier terminal system, a plurality of said container carrier entries, each container carrier entry relating to a container carrier and associated with a preliminary terminal resource demand including said estimated container-related berth workload.

99. The method according to claim 82, wherein said container carrier terminal system comprises a plurality of container carrier entries relating to different container carrier berths of different container carriers and each being associated with respective preliminary terminal resource demands and static carrier information, said method further comprising the steps of:
generating said estimated container-related berth workloads for at least two of said container carrier entries based on said static carrier information; and
allocating a respective subset of said terminal resources to each of said container carrier entries including said allocation of said at least one quay crane to said crane time window to obtain a preliminary terminal resource plan of allocated terminal resources, wherein said step of allocating terminal resources comprises automatically validating said allocated terminal resources of the container carrier entries, the allocated terminal resources including a subset of said at least one quay crane, and
wherein the validating includes automatically establishing whether the allocated terminal resources of the container carrier entries comply with said terminal constraints and said preliminary terminal resource demand associated with said plurality of container carrier entries.

100. A container carrier terminal system comprising data processing equipment configured to store a container carrier entry associated with a scheduled container carrier berth of a container carrier at a container carrier terminal comprising at least one quay crane; the container carrier being associated with static carrier information;
characterized in that the container carrier terminal system comprises a workload predictor configured to generate an estimated container-related berth workload associated with said container carrier berth based on said static carrier information; and
the container carrier terminal system being configured to use data processing equipment to perform and store an allocation of said at least one crane to a crane time window which lies at least partially within an expected duration of said container carrier berth, wherein said allocation is performed in said container carrier terminal system prior to said container carrier berth and is based on said estimated container-related berth workload.

101. The container carrier terminal system of claim 100, wherein said container carrier terminal system comprises a model of said container carrier terminal executed on data processing equipment, said model comprising representations of terminal resources and terminal constraints relating to said terminal resources, said representations of terminal resources including representations of said at least one quay crane; and wherein said container carrier entry is associated with a preliminary terminal resource demand including said estimated container-related berth workload.
